(19) United States
(12) Patent Application Publication
(10) Pub. No.: US 2025/0348708 A1
(43) Pub. Date: Nov. 13, 2025

(54) PROMPT ENGINEERING AND IN-CONTEXT EXAMPLE SELECTION FOR LARGE LANGUAGE MODELS

(71) Applicant: Optum, Inc., Minnetonka, MN (US)

(72) Inventors: Joel David Stremmel, Iowa City, IA (US); Ardavan Saeedi, Jersey City, NJ (US); Sanjit Singh Batra, Redwood City, CA (US)

(21) Appl. No.: 18/657,303

(22) Filed: May 7, 2024

(51) Int. Cl. G06N 3/0455; G06F 16/332; G06N 3/096

(52) U.S. Cl. CPC G06N 3/0455; G06F 16/3329; G06N 3/096

(57) ABSTRACT

Various embodiments of the present disclosure provide prompt engineering and iterative, feedback-based generative techniques that improve traditional LLM technology, including extractive LLM techniques. The techniques may include generating, using a machine learning classification model, a resolution capability classification for an input data object that comprises an input question and an input document; generating using a large language model (LLM), an initial predictive output for the input data object based on an initial generative model prompt for the input data object; identifying a classification model output divergence based on a comparison between the resolution capability classification and the initial predictive output; and in response to the classification model output divergence: generating an augmented generative model prompt by modifying the initial generative model prompt with a representation of the resolution capability classification, and generating, using the LLM, an updated predictive output based on the augmented generative model prompt.

### BACKGROUND

Various embodiments of the present disclosure address technical challenges related to natural language processing and, more specifically, the application of large language modeling techniques in question-answering contexts. In this regard, while helpful in question-answering contexts, traditional large language models (LLMs) are subject to a number of technical challenges, including a prevalence to hallucinate data, requirements for large training datasets and prompts tailored for a specific scenario, among others, that lead to inaccurate and unreliable outputs. The hallucination issue is a technical problem that is specific to LLMs. To address this issue, some question-answering techniques leverage extractive LLMs that constrain their answers to a corpus of supporting evidence provided with a question. In such a case, the answers may be grounded in the supporting evidence to prevent hallucinations that are prevalent in LLMs, thereby improving the reliability of LLM outputs.

However, traditional extractive LLMs require prohibitively expensive operations to maintain their performance. For example, extractive LLMs require continuous training and robust training datasets to maintain their accuracy as patterns within data change over time. Moreover, even with the right dataset, extractive LLMs still require specific prompts that are tailored to a particular question. To achieve a reliable answer, the specific prompts must be augmented with sufficient prompt examples to guide the extractive LLM to the correct solution. Identifying the best performing prompt examples remains a technical challenge that directly impacts the performance of LLMs. For example, traditional prompt engineering techniques for selecting prompt examples typically select question-answer pairs most similar to an input question. These techniques are susceptible to overfitting a model to specific annotation patterns, which limits the accuracy of an LLM with respect to complex or new questions.

Moreover, traditional extractive LLMs leverage a single prompt to achieve an answer. By doing so, traditional extractive LLMs operate on an all or nothing basis and fail to account for failures introduced by an inaccurate prompt, complex input question, or other abnormalities. In other words, traditional extractive LLMs, while accurate in some respects, lack the flexibility to reliably handle unforeseen circumstances, which are highly prevalent given the nascent stages of LLM technology.

Various embodiments of the present disclosure make important contributions to traditional natural language processing and large language modeling techniques by addressing these technical challenges, among others.

### BRIEF SUMMARY

Various embodiments of the present disclosure provide prompt engineering and iterative, feedback-based generative techniques that improve traditional LLM technology, including extractive LLM techniques. To do so, some embodiments of the present disclosure provide a multi-stage prompt engineering technique for automatically identifying dual purpose prompt examples tailored to a particular model input. Using some of the techniques of the present disclosure, the multi-purpose prompt examples may be incorporated to an initial no-shot prompt for an LLM. To improve LLM performance, some techniques of the present disclosure may apply a suite of prompt example selection mechanisms to surface dual purpose prompt examples that target potential nuances of a model input. This empowers an LLM to flexibly handle model inputs of any range of complexity, including simple questions that align with historical patterns, complex questions with few in-context examples, and historically mistake prone questions associated with historically low model performance.

In some embodiments of the present disclosure, an iterative, feedback-based generative techniques are applied either individually or in combination with the multi-stage prompt engineering technique to further improve LLM performance for extract question-answering tasks. To do so, the iterative, feedback-based generative techniques of the present disclosure may implement an LLM-agent ensembler configured to incorporate feedback from complementary models to tailored to different components of the question-answering task. For example, the complementary models may include classification and/or natural language processing techniques that excel at portions of a question-answering task, without achieving the performance provided by LLMs. Using the techniques of the present disclosure, outputs from these model may be used in an iterative feedback loop to verify the outputs of an LLM and, in the case of a verification failure, iteratively augment model prompts for the LLM to until a convergence is achieved. By doing so, the iterative, feedback-based generative techniques of the present disclosure improve the performance of LLM models, while providing failsafe verification mechanisms that directly address reliability challenges unique to LLM technology.

In some embodiments, a computer-implemented method comprising generating, by one or more processors and using a machine learning classification model, a resolution capability classification for an input data object that comprises an input question and an input document; generating, by the one or more processors and using a large language model (LLM), an initial predictive output for the input data object based on an initial generative model prompt for the input data object; identifying, by the one or more processors, a classification model output divergence based on a comparison between the resolution capability classification and the initial predictive output; and in response to the classification model output divergence: generating an augmented generative model prompt by modifying the initial generative model prompt with a representation of the resolution capability classification, and generating, using the LLM, an updated predictive output based on the augmented generative model prompt.

In some embodiments, a computing system comprising memory and one or more processors communicatively coupled to the memory, the one or more processors configured to generate, using a machine learning classification model, a resolution capability classification for an input data object that comprises an input question and an input document; generate, using an LLM, an initial predictive output for the input data object based on an initial generative model prompt for the input data object; identify a classification model output divergence based on a comparison between the resolution capability classification and the initial predictive output; and in response to the classification model output divergence: generate an augmented generative model prompt by modifying the initial generative model prompt with a representation of the resolution capability classification, and generate, using the LLM, an updated predictive output based on the augmented generative model prompt.

In some embodiments, one or more non-transitory computer-readable storage media including instructions that, when executed by one or more processors, cause the one or more processors to generate, using a machine learning classification model, a resolution capability classification for an input data object that comprises an input question and an input document; generate, using an LLM, an initial predictive output for the input data object based on an initial generative model prompt for the input data object; identify a classification model output divergence based on a comparison between the resolution capability classification and the initial predictive output; and in response to the classification model output divergence: generate an augmented generative model prompt by modifying the initial generative model prompt with a representation of the resolution capability classification, and generate, using the LLM, an updated predictive output based on the augmented generative model prompt.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for a prompt engineering framework in accordance with some embodiments discussed herein.

FIG. 5 is a dataflow diagram showing example data structures and modules for an iterative, feedback-based generative framework in accordance with some embodiments discussed herein.

FIG. 6 is a dataflow diagram showing example data structures and modules for an end-to-end prompt engineering and interactive feedback-based generative framework in accordance with some embodiments discussed herein.

FIG. 7 is a flowchart diagram of an example process for implementing a prompt engineering framework in accordance with some embodiments discussed herein.

FIG. 8 is a flowchart diagram of an example process for implementing a first stage of an iterative, feedback-based generative framework in accordance with some embodiments discussed herein.

FIG. 9 is a flowchart diagram of an example process for implementing a second stage of an iterative, feedback-based generative framework in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

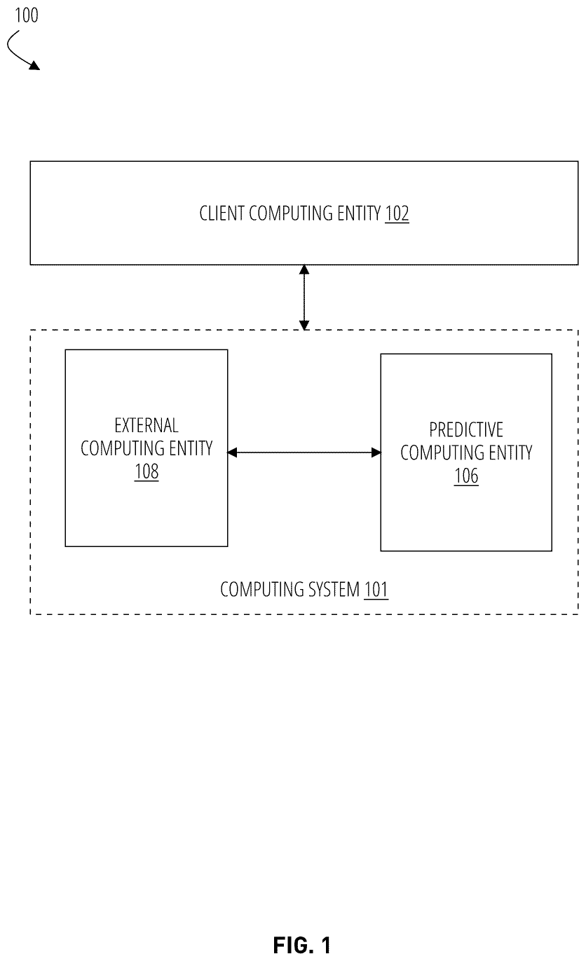

FIG. 1 provides an example overview of an architecture 100 in accordance with some embodiments of the present disclosure. The architecture 100 includes a computing system 101 configured to receive requests, such as a generative text request, from client computing entities 102, process the requests to generate predictive outputs, and provide the predictive outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate embeddings, resolution capability classification, generative model prompts, predictive outputs, and/or the like. The models may form a machine learning pipeline that may be configured to automatically generate a resolution capability classification, a corroborative resolution outputs, and initial predictive output for a particular generative task and then leverage the resolution capability classification, corroborative resolution output, and initial predictive output to generate an augmented generative model prompt to perform the generative task. This technique will lead to more accurate and reliable generative text modelling techniques that may be efficiently used for diverse set of different use cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as few-shot prompts, predictive outputs, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative text techniques, and/or the like) described herein. The external computing entities 108, for example, may include and/or be associated with one or more entities that may be configured to receive, transmit, store, manage, and/or facilitate datasets, such as reference datasets, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

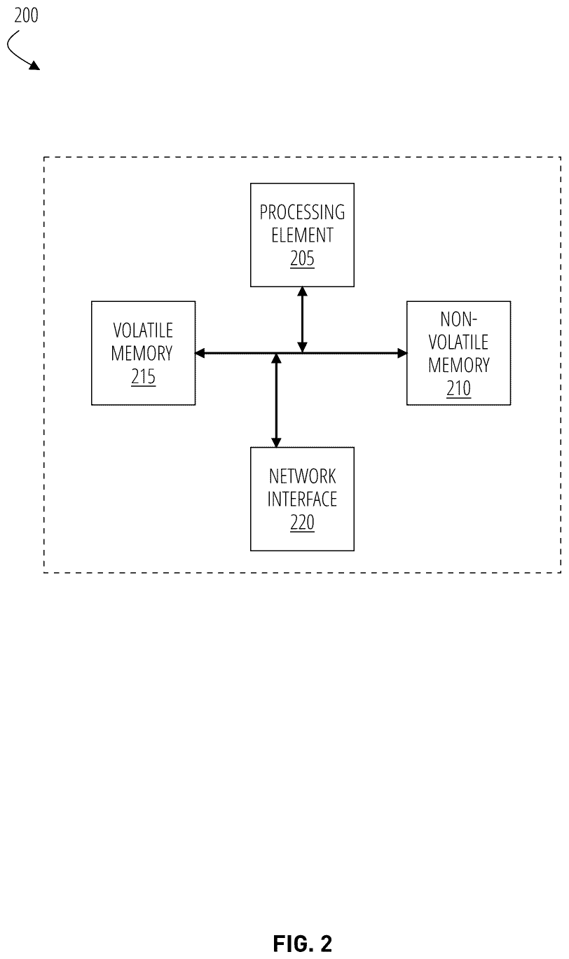

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

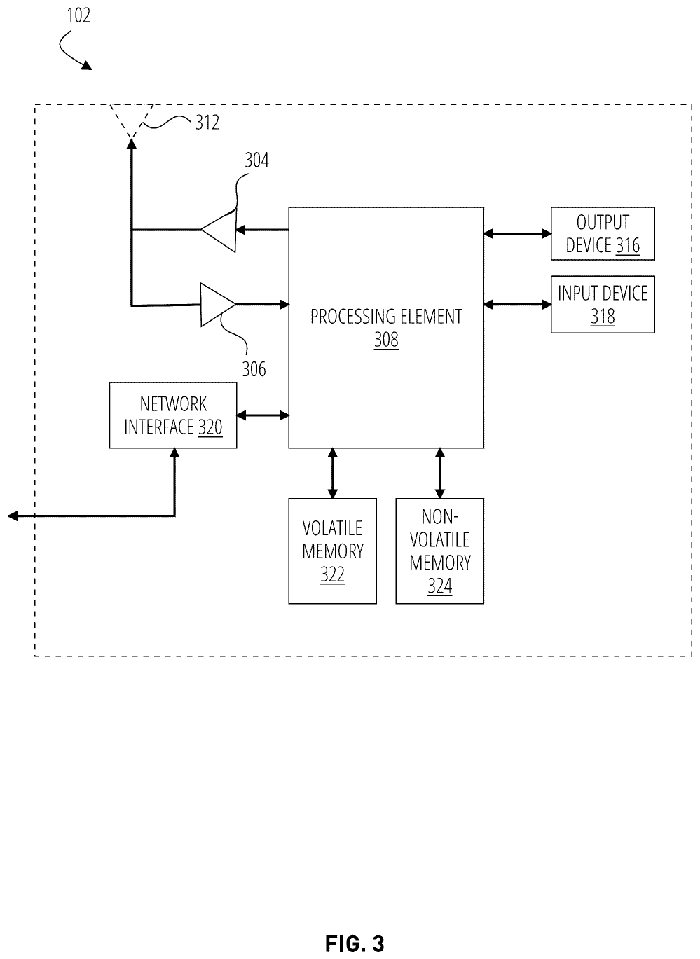

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “generative text request” refers to a message (e.g., an inter-service message, intra-service message, network message, etc.) that is descriptive of a request to generate a predictive output. In some embodiments, a generative text request May include a request to generate a predictive output based on an input data object. The input document, for example, may include an input question and an input document.

In some embodiments, the term “input question” refers to a data entity that describes a request for information associated with an input document. An input question, for example, may include text inputs that define a natural language query. The input question and the input document may be included in a generative model prompt for an LLM configured to generate a predictive output for the input question based on the input document.

In some embodiments, the term “LLM” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). An LLM may include any type of model configured, trained, and/or the like to generate a predictive output (e.g., natural language text) in response to a textual prompt, such as a generative model prompt, as described herein. For example, the LLM may include a generative machine learning model such as a generative pre-trained transformer (GPT) model. In some examples, a variable (e.g., “llm_answerable” or the like) may be encoded based on the predictive output of the LLM.

In some embodiments, the term “predictive output” refers to a model output generated by an LLM for an input data object. For example, a predictive output may include an answer span extracted from an input document that answers an input question. The answer span, for example, may include a segment of text that reflects a portion of evidence from an input document that answers an input question. In some embodiments, a predictive output is generated by inputting a generative model prompt to the LLM. For instance, using one or more techniques of the present disclosure, a few-shot prompt may be generated for an input data object. The few-shot prompt may include an input question, an input document, and one or more in-context prompt examples. The predictive output may include an answer to the input question that is extracted from the input document and formatted based on the one or more in-context prompt examples. In some examples, a predictive output may include one of a plurality of predictive outputs for an input data object that may be refined, using some of the techniques of the present disclosure, by augmenting the few-shot prompt provided to the LLM. For instance, the plurality of predictive outputs may include an initial predictive output and one or more updated predictive outputs that are iteratively refined using interactively augmented model prompts, as described herein.

In some embodiments, the term “input document” refers to a data entity that describes one or more text inputs that provide evidence for a predictive output of an input question. An input document, for example, may include a closed set of evidence for answering an input question. An input document may be input to a machine learning model with the input question to contain the answer to the input question to the evidence from the input document. An input document may include a plurality of different units of text that are related to an input question. The extent and type of units of text may depend on the input question and/or prediction domain associated with the input question. As one example, in a healthcare domain, an input document may include clinical records for a patient, such as one or more radiology reports, clinical notes, or the like.

In some embodiments, the term “reference dataset” refers to a data structure that describes a plurality of data objects for a prediction domain. An example reference dataset may include any type (and any number) of data storage structures including, as examples, one or more linked lists, databases (e.g., relational databases, graph database, etc.), and/or the like. In some examples, a reference dataset may include a training dataset for one or more machine learning models. For example, a reference dataset may include a plurality of reference data objects, each reflective of an annotated question-answer pair for a prediction domain that may be used as a training entry and/or as an in-context prompt example for one or more different machine learning models of the present disclosure. In some examples, a reference dataset may be domain specific. For instance, a reference dataset may include a plurality of annotated question-answer pairs that are related to the particular prediction domain. As one example, in a healthcare domain, a reference dataset may include annotated question-answer pairs from one or more healthcare domain fields, such as radiology, primary care, dermatology, and/or the like. In some embodiments, an annotated question-answer pair includes a reference question, a reference answer, and a reference document (e.g., document context). In some examples, the reference dataset is leveraged to generate a generative model prompt for an LLM to output a predictive output for an input question based on the corresponding input document. In some examples, the generative model prompt may include a few-shot prompt. For instance, one or more annotated question-answer pairs may be selected from a reference dataset based on the input question and/or corresponding input document and included in a few-shot prompt as one or more in-context prompt examples. To improve model performance, in some examples, the one or more selected annotated question-answer pairs may be intelligently selected to include a combination of simple and complex annotated question-answer pairs. The annotated question-answer pairs may be selected using an in-context selection mechanism.

In some embodiments, an “in-context example selection mechanism” refers to a prompt engineering subroutine configured to intelligently filter and select in-context examples for a generative model query. An in-context example selection mechanism may include a data consultant agent routine that is configured to interact with an LLM to iteratively generate a model prompt for the LLM based on one or more prompt building criteria and/or an expected or actual performance of the LLM. For instance, an in-context example selection mechanism may receive, as an input, an input question and an input document and provide, as an output, one or more annotated question-answer pairs that satisfy one or more prompt requirements associated with an LLM. Examples of in-context example selection mechanisms include nearest neighbor-based selection mechanism, mistake-based selection mechanism, question-context lexical overlap selection mechanism, question-answer lexical overlap selection mechanism, or the like

In some embodiments, the term “simple annotated question-answer pair” refers to an annotated question-answer pair that is associated with a low measure of difficulty with respect to an input data object. In some examples, a simple annotated question-answer pair may be randomly selected from a set of simple annotated question-answer pairs that are associated with a historically high performance of the LLM. The set of simple annotated question-answer pairs, for example, may include annotated question-answer pairs that are positively predicted during one or more training and/or validation operations of the LLM.

In addition, or alternatively, a simple annotated question-answer pair may include an annotated question-answer pair that is semantically and/or syntactically similar to an input question of the input data object. For instance, a simple annotated question-answer pair may be output by an in-context example selection mechanism configured to identify and select one or more annotated question-answer pairs that are similar to the input data object. Any of a plurality of in-context example selection mechanisms may be leveraged to select a simple annotated question-answer pair. In some examples, a nearest neighbor-based selection mechanism is leveraged to select one or more simple annotated question-answer pairs for an input question based on an embedding similarity between one or more reference questions and an input question of an input data object.

In some embodiments, the term “nearest neighbor-based selection mechanism” refers to an in-context example selection mechanism configured to select one or more simple annotated question-answer pairs for an input question. A nearest neighbor-based selection mechanism may include identifying N reference questions (e.g., from a reference dataset) that are closest in embedding space to the input question, and selecting the N reference questions along with their corresponding reference answer and refence document to be included as in-context example in a generative model prompt.

For instance, a plurality of reference embeddings for a plurality of annotated question-answer pairs may be generated based on the plurality of reference questions from the plurality of annotated question-answer pairs. One or more simple annotated question-answer pairs may then be selected from the plurality of annotated question-answer pairs based on the output of one or more embedding similarity comparison techniques. The one or more embedding similarity comparison techniques, for example, may be configured to output a similarity measure for a respective reference embedding with respect to an input embedding for the input question. Examples of embedding similarity comparison techniques include a cosine similarity, Euclidean distance, and/or the like.

In some embodiments, the term “reference embedding” refers to an encoded data entity (e.g., one or more vectors, etc.) that corresponds to a reference question from an annotated question-answer pair. A reference embedding may include any type of text embedding including Word2Vec, bidirectional encoder representations from transformers (BERT) embeddings, and/or the like. In some embodiments, a reference embedding may be generated using a pretrained encoder-only language model or other machine learning embedding models.

In some embodiments, the term “input embedding” refers to an encoded data entity (e.g., one or more vectors, etc.) that corresponds to an input question. An input embedding may include any type of text embedding including Word2Vec, bidirectional encoder representations from transformers (BERT) embeddings, and/or the like. In some embodiments, an input embedding may be generated using a pretrained encoder-only language model or other machine learning embedding models.

In some embodiments, the term “machine learning embedding model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning embedding model may include any type of model configured, trained, and/or the like to generate an intermediate output, such as a feature embedding, for a unit of text. For example, a machine learning embedding model may be leveraged to generate a reference embedding for a reference question. As another example, a machine learning embedding model may be leveraged to generate an input embedding for an input question. A machine learning embedding model may include one or more of any type of machine learning model including one or more supervised, unsupervised, semi-supervised, reinforcement learning models, and/or the like. For instance, a machine learning embedding model may include a bidirectional transformer that may be trained using training data from a reference dataset to generate one or more domain specific embeddings for a prediction domain. In some embodiments, the machine learning embedding model includes a pretrained encoder-only language model.

In some embodiments, the term “pretrained encoder-only language model” refers to a type of machine learning embedding model. The pretrained encoder-only language model may be previously trained using an unsupervised training technique and domain-specific training data. For instance, the pretrained encoder-only language model may be trained using a reference dataset associated with the prediction domain. In a healthcare domain, for example, a pretrained encoder-only model may be trained on a reference dataset comprising radiology-based question-answer pairs to generate reference embeddings and input embeddings that are leveraged (e.g., using nearest neighbor-based selection mechanism) to select simple annotated question-answer pairs for a radiology-based input question and corresponding radiology-based input document. In this manner, the pretrained encoder-only language model, trained using an unsupervised training technique and domain-specific training data, may provide improved performance relative to pretrained encoder-only language models (and other models) trained on generic text.

In some embodiments, the term “complex annotated question-answer pair” refers to an annotated question-answer pair that is associated with a high measure of difficulty with respect to an input data object. A complex annotated question-answer pair, for example, may include a reference question that is determined, using one or more in-context example selection mechanisms, as challenging for a particular LLM to answer or answer accurately. Examples of a complex annotated question-answer pairs include mistake prone annotated question-answer pairs, context dissimilar question-answer pairs, answer dissimilar question-answer pair, or the like. For instance, a complex annotated question-answer pair may be output of an in-context example selection mechanism configured to identify and select one or more annotated question-answer pairs that are dissimilar to the input question and/or input document and/or associated with a failure question scenario. Any of a plurality of in-context example selection mechanisms may be leveraged to select complex annotated question-answer pairs for an input question. In some examples, one or more of a mistake-based selection mechanism, question-context lexical overlap selection mechanism, or a question-answer lexical overlap selection mechanism are leveraged to select one or more complex annotated question-answer pairs for an input question. Complex-annotated question-answer pairs may be included in a generative model prompt for an LLM to aid the LLM when it encounters similarly challenging input questions.

In some embodiments, the term “mistake prone annotated question-answer pair” refers to an annotated question-answer pair associated with a failure question scenario with a particular LLM. For example, a mistake prone annotated question-answer pair may include an annotated question-answer pair having a reference question that the LLM previously failed to answer (e.g., during one or more training and/or validation operations, etc.). For example, a reference question from an annotated question-answer pair may be previously included in a generative model prompt for the LLM. The annotated question-answer pair may be flagged as a mistake prone annotated question-answer pair in the event of a failure question scenario in which the LLM fails to output a predictive output that matches (e.g., within a threshold degree of similarity, etc.) the reference answer to the reference question. In such a case, the mistake prone annotated question-answer pair may be output from a mistake-based selection mechanism for the annotated question-answer pair.

In some embodiments, the term “failure question scenario” refers to a data entity that describes an occurrence, where the output of an LLM fails to satisfy one or more predetermined criteria. In some embodiments, the predetermined criteria include a generation of a predictive output, by an LLM, to a reference question that matches a reference answer within a degree of similarity. For instance, a failure question scenario may define a semantic and/or syntactic similarity threshold (e.g., 80%, 90%, etc.). A failure question scenario may be identified in the event that a comparison between a predictive output and a reference answer fails to achieve the semantic and/or syntactic similarity threshold.

In some embodiments, the term “mistake-based selection mechanism” refers to a prompt engineering subroutine for selecting one or more mistake prone annotated question-answer pairs for an input data object. In some examples, the mistake-based selection mechanism is configured to provide, via one or more generative model prompts, a plurality of reference questions from the reference dataset to an LLM to generate a response output (e.g., an answer span) for the plurality of reference questions. The mistake-based selection mechanism may generate a set of mistake prone annotated question-answer pairs based on the performance of the LLM with respect to the plurality of reference questions. For instance, the plurality of reference questions may be provided as input to the LLM using any of a plurality of prompt templates, such as no-shot template (e.g., zero-shot prompt), random selection, or the like. The mistake-based selection approach identifies hard examples by including examples in the prompt which the LLM failed to answer. These examples may be sourced from the reference dataset and not the test data to avoid overfitting. This may require first applying the LLM to the reference dataset, optionally using other approaches to select in-context examples. Random selection or zero-inferences are examples of some of the approaches that can be used select-in context examples.

In some embodiments, a mistake-based selection mechanism selects one or more mistake prone annotated question-answer pairs from the set of mistake prone annotated question-answer pairs for an input data object. The one or more mistake prone annotated question-answer pairs may be randomly sampled and/or selected based on a syntactic and/or semantic similarity with an input question of the input data object. The one or more mistake prone annotated question-answer pairs may be leveraged as in-context examples of a generative model prompt to an LLM.

In some embodiments, the term “context dissimilar question-answer pair” refers to an annotated question-answer pair with a low overlap between a respective reference question and reference document provided to answer the reference question. A context dissimilar question-answer pair may be identified based on similarity score between the respective reference question and reference document. In some examples, a context dissimilar question-answer pair may include an annotated question-answer pair with a similarity score that fails to satisfy a similarity threshold (e.g., 50%, 90%, 95%, etc.). A similarity score, for example, may be generated using a question-context lexical overlap selection mechanism. For instance, a context dissimilar question-answer pair may include an annotated question-answer pair that is assigned or otherwise associated with a low question-context lexical overlap based on a similarity score output of a question-context lexical overlap selection mechanism. In this way, one or more in-context examples of an engineered prompt may include reference questions and answers that may help an LLM when it encounters similarly difficult input questions with low overlap with reference document.

In some embodiments, the term “question-context lexical overlap selection mechanism” refers to a prompt engineering subroutine for selecting one or more context dissimilar question-answer pairs for an input data object. The question-context lexical overlap selection mechanism is configured to determine a question-context lexical overlap classification for an annotated question-answer pair using one or more natural language and/or embedding comparison techniques. For instance, a question-context lexical overlap classification may be based on an n-gram similarity between a reference question and reference document (e.g., document context). As an example, the question-context lexical overlap classification may be determined by determining a count of n-grams in common between the reference question and reference document associated with the reference question and generating a similarity score for the annotated question-answer pair based on the count of n-grams. The question-context lexical overlap selection mechanism may be configured to assign a question-context lexical overlap classification to annotated question-answer pairs based on the similarity scores associated with a respective annotated question-answer pair and select one or more annotated question-answer pairs associated with a low question-context lexical overlap classification as context dissimilar question-answer pairs to be included in a few-shot prompt for an LLM. For example, an annotated question-answer pairs associated with a similarity score that fails to satisfy (e.g., below) a similarity threshold (e.g., 50%, 90%, 95%, etc.) may be assigned a low question-context lexical overlap classification, while annotated question-answer pairs associated with a similarity score that satisfies (e.g., equal to, above, or the like) the similarity threshold may be assigned a high question-context lexical overlap classification. In some embodiments, a question-context lexical overlap selection mechanism selects one or more context dissimilar question-answer pairs from a set of context dissimilar question-answer pairs for an input data object. The one or more context dissimilar question-answer pairs may be randomly sampled and/or selected based on a syntactic and/or semantic similarity with an input question of the input data object. The one or more context dissimilar question-answer pairs may be leveraged as in-context examples of a generative model prompt to an LLM.

In some embodiments, the term “answer dissimilar question-answer pair” refers to an annotated question-answer pair associated with a low overlap between a respective reference question and reference answer provided as the answer to the reference question. An answer dissimilar question-answer pair may be identified based on similarity score between the respective reference question and reference answer. In some examples, an answer dissimilar question-answer pair may include an annotated question answer pair with a similarity score that fails to satisfy a similarity threshold (e.g., 50%, 90%, 95%, etc.). A similarity score, for example, may be generated using a question-context lexical overlap selection mechanism. For instance, an answer dissimilar question-answer pair may include an annotated question-answer pair that is assigned or otherwise associated with a low question-answer lexical overlap based on a similarity score output of a question-answer lexical overlap selection mechanism. In this way, one or more in-context examples of an engineered prompt may include reference questions and answers that may help an LLM when it encounters similarly difficult input questions with low overlap with the answer to the input question.

In some embodiments, the term “question-answer lexical overlap selection mechanism” refers to a prompt engineering subroutine for selecting one or more answer dissimilar question-answer pairs for an input data object. The question-answer lexical overlap selection mechanism is configured to determine a question-answer lexical overlap classification for an annotated question-answer pair using one or more natural language and/or embedding comparison techniques. For instance, a question-answer lexical overlap classification may be based on an n-gram similarity between a reference question and reference answer. As an example, the question-answer lexical overlap classification may be determined by determining a count of n-grams in common between the reference question and reference answer associated with the reference question and generating a similarity score for the annotated question-answer pair based on the count of n-grams. The question-answer lexical overlap selection mechanism may be configured to assign a question-answer lexical overlap classification to annotated question-answer pairs based on the similarity scores associated with a respective annotated question-answer pair and select one or more annotated question-answer pairs associated with a low question-answer lexical overlap classification as answer dissimilar question-answer pairs to be included in a generative model prompt. For example, an annotated question-answer pair associated with a similarity score that fails to satisfy (e.g., below) a similarity threshold (e.g., 50%, 90%, 95%, etc.) may be assigned a low question-answer lexical overlap classification while annotated question-answer pairs associated with a similarity score that satisfies (e.g., equal to, above, or the like) the similarity threshold may be assigned a high question-answer lexical overlap classification. In some embodiments, a question-answer lexical overlap selection mechanism selects one or more answer dissimilar question-answer pairs from a set of answer dissimilar question-answer pairs for an input data object. The one or more answer dissimilar question-answer pairs may be randomly sampled and/or selected based on a syntactic and/or semantic similarity with an input question of the input data object. The one or more answer dissimilar question-answer pairs may be leveraged as in-context examples of a generative model prompt to an LLM.

In some embodiments, the term “prompt template” refers to a data entity that describes a predefined structure for a generative model prompt. A prompt template, for example, may include a no-shot prompt template, a few-shot prompt template, and/or the like. The prompt template may include one or more model-specific fields that may be tailored to a particular LLM. In addition, or alternatively, the prompt template may include one or more instruction sets for guiding an LLM for a particular generative task. In some examples, the instruction sets may be dynamically tailored and/or selected for a specific generative task. For instance, a prompt template may be selected from a plurality of prompt templates based on an efficacy of the template's instruction set for the specific generative task.

In some embodiments, the term “resolution capability classification” refers to a data entity that describes a machine learning classification model output. The resolution capability classification may be indicative of whether an input question from an input data object is answerable based on an input document associated with the input question. A resolution capability classification may include a positive classification (e.g., label “1”) or a negative classification (e.g., label “0”). In some examples, a variable (e.g., “clf_answerable” or the like) may be encoded based on the resolution capability classification for the input data object.

In some embodiments, the term “machine learning classification model” refers to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. A machine learning classification model may include any type of model configured, trained, and/or the like to generate a resolution capability classification for an input question. A machine learning classification model may include one or more of any type of machine learning models including one or more supervised, unsupervised, semi-supervised, reinforcement learning models, and/or the like. A machine learning classification model may be configured to receive an input question and input document corresponding to the input question and classify the input question based on the likelihood of the input question being answerable based on the input document. By way of example, a machine learning classification model may be previously trained to classify an input question into a predefined category using a reference dataset associated with the prediction domain. For example, during a training phase, the machine learning classification model may be trained to assign a positive resolution capability classification (e.g., label “1”) to a reference question if the reference question is answerable using the reference document or assign a negative resolution capability classification (e.g., label “0”) if the reference document is not answerable using the reference document. In some embodiments, the machine learning classification model includes a language model. By way of example, in a healthcare domain, the machine learning classification model may include a BioClinicalROBERTa model that is finetuned on a clinical dataset, such as RadQA.

In some embodiments, the machine learning classification model is trained using one or more annotated question answer pairs from the reference dataset. For instance, the machine learning classification model may be trained using training entries in the form of:
“<Question Text><SEP TOKEN><Document Context>”
   with 0 and 1 labels depending on whether the question in answerable from the document.

In some embodiments, the term “corroborative resolution output” refers to a data entity that describes a natural language question-answering model output. The corroborative resolution output may comprise an answer to an input question as determined by a natural language question-answering model. The corroborative resolution output may be leveraged to provide feedback to an LLM.

In some embodiments, the term “natural language question-answering model” refers to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. A natural language question-answering model may include any type of model configured, trained, and/or the like to generate a corroborative resolution output for an input question. A natural language question-answering model may include one or more of any type of machine learning models including one or more supervised, unsupervised, semi-supervised, reinforcement learning models, and/or the like. A natural language question-answering model may be configured to receive an input question and input document corresponding to the input question and process to the input question and input document to generate a corroborative resolution output. By way of example, a natural language question-answering model may be previously trained to generate a corroborative resolution output for an input data object using a reference dataset associated with the prediction domain. In some examples, the natural language question-answering model is a fine-tuned natural language question-answering model.

In some embodiments, the natural language question-answering model is configured to work similarly to the machine learning classification model but configured to generate an answer to the input question of the input data object directly and provide the generated answer as feedback to the LLM. If the answer generated by the natural language question-answering model is the same as that of the LLM or substantially similar according to (i) n-gram overlap similarity or (ii) embedding similarity of the corroborative resolution output (e.g., generated answer by the natural language question-answering model and generated answer by the LLM, then the natural language question-answering model and the LLM agree. If the answer generated by the natural language question-answering model is not the same as that of the LLM or not substantially similar according to (i) n-gram overlap similarity or (ii) embedding similarity of the corroborative resolution output, feedback may be provided to the LLM in a similar manner as described above with respect to the machine learning classification model. For instance, the corroborative resolution output (e.g., answer to the input question) from the fine-tuned natural language question-answering model or other question-answering model may be provided in a generative model prompt for the LLM as follows: “You provided response X to question Q but another natural language question-answering model provided response Y. Based on this feedback, please produce a new response to the question based on the reference document.” In this regard, the LLM can then integrate this feedback to produce an improved response.

In some embodiments, the term “initial generative model prompt” refers to an initial prompt for instructing an LLM to generate an initial predictive output. An initial generative model prompt may include a few-shot prompt comprising a plurality of prompt examples (e.g., in-context examples). An initial generative model prompt may be augmented to generate an augmented generative model prompt.

In some embodiments, the term “augmented generative model prompt” refers to a modified initial generative model prompt. By way of example, an augmented generative model prompt may be generated by augmenting the initial generative model prompt with one or more text inputs based on output of one or more machine learning models (e.g., one or more machine learning classification model, one or more natural language question-answering models, etc.).

In some embodiments, the term “classification model output divergence” refers to a data entity indicative of a discrepancy or otherwise disagreement between two model outputs.

For instance, a classification model output divergence may be indicative of a discrepancy/disagreement between a resolution capability classification output of a machine learning classification model and a predictive output (e.g., initial predictive output, updated predictive output) of an LLM. An LLM agent model communicatively connected to the LLM may be configured to augment the generative model prompt for the LLM in response to a classification model output divergence.

In some embodiments, the term “corroborative output divergence” refers to a data entity indicative of a discrepancy or otherwise disagreement between two model outputs. For instance, a corroborative output divergence may be indicative of a discrepancy/disagreement between a corroborative resolution output of a natural language question-answering model and a predictive output (e.g., initial predictive output, updated predictive output) of an LLM. In some examples, the corroborative output divergence may be identified based on a corroborative similarity score between the corroborative resolution output and the predictive output, In some examples, the corroborative output divergence may be identified based on an n-gram similarity between the corroborative resolution output and the predictive output. An LLM agent model communicatively connected to the LLM may be configured to augment the generative model prompt for the LLM in response to the on the corroborative output divergence.

In some embodiments, the term “LLM agent model” refers to a computer-implemented process for providing feedback to an LLM. For example, the LLM agent model may be configured to provide feedback to the LLM based on the output of a comparison of the predictive output of the LLM to a resolution capability classification output of a machine learning classification model and/or based on a comparison of the predictive output of the LLM to a corroborative resolution output of a natural language question-answering model. The LLM agent model may be configured to provide feedback to the LLM via the generative model prompt. For example, the LLM agent model may be configured to provide feedback to the LLM by augmenting the generative model prompt for the LLM with text inputs. The text inputs, for example, may comprise representation of resolution capability classification outputs of one or more machine learning classification models and/or representations of corroborative resolution outputs of one or more natural language question-answering model.

In some examples, the LLM agent model may be configured to perform one or more resolution capability iterations until a resolution capability stop condition is satisfied and provide feedback to the LLM for each resolution capability iteration. In some examples, the resolution capability stop condition may be a threshold number of one or more resolution capability iterations (e.g., N maximum iterations, where N is an integer) or a classification model output convergence. By way, of example, if the model outputs after the threshold number of one or more resolution capability iterations still do not converge, a determination whether the input question is answerable may be based on a random determination or based on knowledge about the performance of the machine learning classification model and/or LLM. In some examples, the LLM agent model may be configured to perform one or more corroborative resolution iterations until a corroborative stop condition is satisfied and provide feedback to the LLM for each corroborative resolution iteration. In some embodiments, the corroborative stop condition may be a threshold number of one or more corroborative resolution iterations (e.g., N maximum iterations, where N is an integer) or a corroborative output convergence.

In some embodiments, the term “resolution capability iterations” may refer to a computer-implemented process for providing feedback to an LLM based on a machine learning classification model. A resolution capability iteration may include comparing the resolution capability classification output of the machine learning classification model for an input question to the predictive output classification of the LLM for the input question in order to determine whether the outputs converge or diverge. The resolution capability iteration may include encoding a variable, such as “clf_anwerable”, based on the resolution capability classification output and encoding a variable, such as “llm_answerable”, based on the predictive output classification of the LLM. The resolution capability iteration may include providing feedback to the LLM in the form of augmented generative model output if the outputs diverge (e.g., where the result of the comparison is a classification model output divergence). Feedback may be provided to the LLM by augmenting the generative model prompt for the LLM with one or more text inputs. The text input may be selected from a plurality of text inputs based on the output of the resolution capability iteration. Examples of such text inputs include, but not limited to, “You thought the question could be answered from the supplied document. Are you sure? The document may not actually contain an answer to the question”, “You thought the question did not have an answer in the supplied document. Are you sure? The document may actually contain an answer to the question”.

In some embodiments, the term “corroboration capability iteration” may refer to a computer-implemented process for providing feedback to an LLM based on a natural language question-answering model. A corroboration capability iteration may include comparing the corroborative resolution output of the natural language-answering model for an input question to the predictive output classification of the LLM for the input question in order to determine whether the outputs converge or diverge. The corroboration resolution iteration may include providing feedback to the LLM in the form of augmented generative model if the outputs diverge (e.g., where the result of the comparison is a corroborative output divergence). Feedback may be provided to the LLM by augmenting the generative model prompt for the LLM with one or more text inputs. The text input may be selected from a plurality of text inputs based on the output of a corroboration capability iteration. Examples of such text inputs include “You provided response X to question Q but another natural language question-answering model provided response Y. Based on this feedback, please produce a new response to the question based on the document context.”

### IV. Overview

Various embodiments of the present disclosure provide in-context example selection techniques and prompt engineering techniques that improve traditional generative text techniques, such as those that leverage LLMs for extractive question-answer (QA) tasks. To do so, some embodiments of the present disclosure provide a generative framework including multiple, iterative multi-stage processes to generate generative model prompts such as few-shot prompts, refine generative model prompts for LLMs based on outputs of other models, and generate predictive outputs using LLMs. To do so, the generative framework may leverage a combination of a multi-stage in-context prompt example selection pipeline and multi-stage prompt engineering pipeline that enable the creation of optimal generative model prompts that improve upon traditional LLM techniques. This, in turn, enables an improved generative text pipeline that directly addresses technical challenges within the realm of generative modeling, such as inaccurate outputs, cost, readability, processing and memory requirements, among others.

In various embodiments, some of the techniques of the present disclosure provide a multi-stage in-context prompt example selection and prompt engineering that enables improved generative model prompts for generative tasks such as extractive question-answer (QA) tasks. Traditional generative techniques can be prohibitively expensive to continue training and, thus, are typically not applied in a few-shot/in-context learning paradigm where example questions and answers are provided to the LLM as part of the prompt. Example embodiments of the present disclosure provides a framework that leverages an LLM agent model to incorporate feedback from consultant models (e.g., machine learning classification models for answerable question classification, natural language question answering model, and/or other models) to improve the accuracy and robustness of the output of LLMs for extractive QA tasks and/or other predictive tasks.

Examples of technologically advantageous embodiments of the present disclosure include: (i) in-context prompt example selection techniques, (ii) prompt engineering techniques for automatically generating generative model prompts, and (iii) feedback-based predictive outputs generation techniques, among other aspects of the present disclosure. Other technical improvements and advantages may be realized by one of ordinary skill in the art.

### V. Example System Operations

As indicated, various embodiments of the present disclosure make important technical contributions to large language modelling techniques. In particular, systems and methods are disclosed herein that implement prompt engineering and iterative, feedback-based generative techniques to improve LLM performance with respect to various tasks, including question-answering tasks. By doing so, the techniques of the present disclosure may improve the reliability of LLMs, while also expanding the applicability of LLMs to diverse use cases.

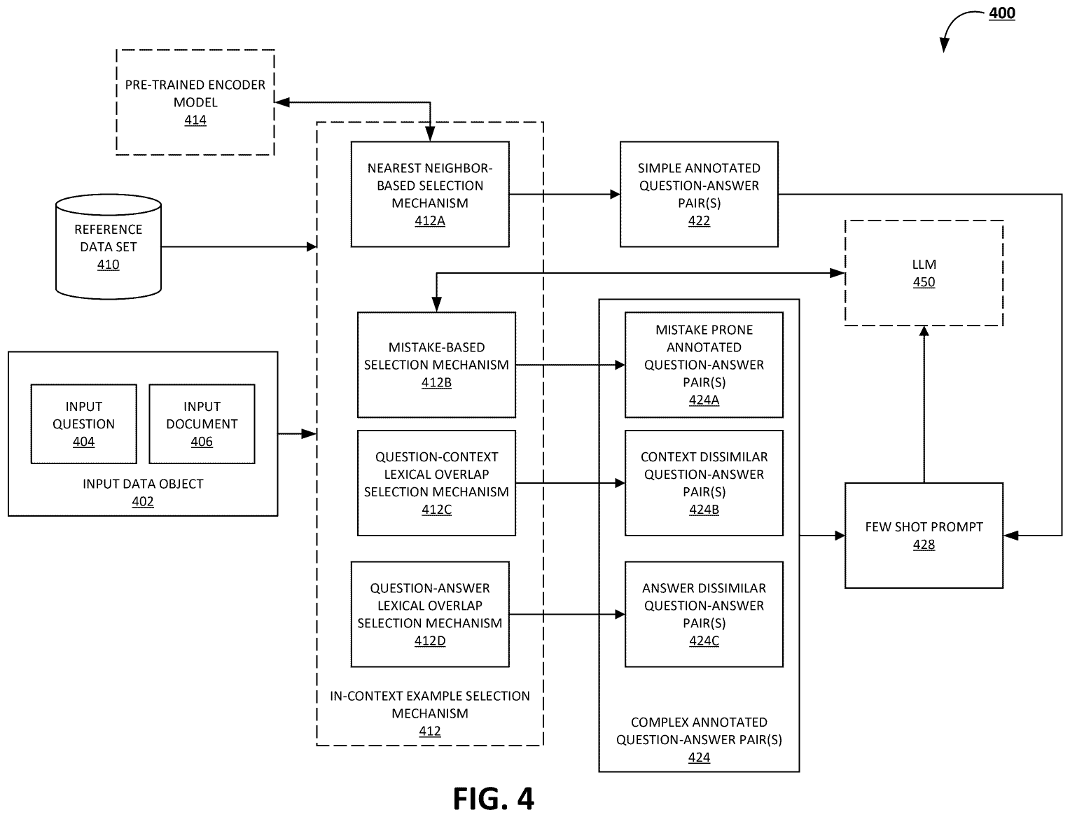

FIG. 4 is a dataflow diagram 400 showing example data structures and modules for a prompt engineering framework in accordance with some embodiments discussed herein. The dataflow diagram 400, for example, illustrates a multi-stage in-context example selection pipeline for generating a generative model prompt, such as the few-shot prompt 428, that incorporates multi-purpose in-context examples from a plurality of different example selection techniques. The few-shot prompt 428, for example, may be tailored to an input data object 402 by identifying a plurality of annotated question-answer pairs from a reference dataset 410. By using the techniques of the present disclosure, the few-shot prompt 428 may aggregate a diverse set of prompt examples that empower an LLM to flexibly manage an input data object 402 of any range of complexity.

In some embodiments, one or more simple annotated question-answer pairs 422 are selected from a reference dataset 410, for the input data object 402. The input data object, for example, may include an input question 404 and an input document 406. In some embodiments, the one or more simple annotated question-answer pairs 422 are selected by generating, using a pretrained encoder-only language model 414, a plurality of reference embeddings for the plurality of annotated question-answer pairs based on the plurality of reference questions; generating, using the pretrained encoder-only language model 414, an input embedding based on the input question; and selecting, using a nearest neighbor-based selection mechanism 412A, the one or more simple annotated question-answer pairs based on an embedding similarity between the input embedding and the plurality of reference questions. In some embodiments, the pretrained encoder-only language model 414 is previously trained using an unsupervised training technique and the reference dataset 410.

In some embodiments, the input question 404 is a data entity that describes a request for information associated with an input document 406. The input question, for example, may include text inputs that define a natural language query. The input question 404 and the input document 406 may be included in a generative model prompt for an LLM 450 configured to generate a predictive output for the input question 404 based on the input document.

In some embodiments, an LLM 450 is a data entity that describes parameters, hyper-parameters, and/or defined operations of a rules-based and/or machine learning model (e.g., model including at least one of one or more rule-based layers, one or more layers that depend on trained parameters, coefficients, and/or the like). An LLM 450 may include any type of model configured, trained, and/or the like to generate a predictive output (e.g., natural language text) in response to a textual prompt, such as a generative model prompt, as described herein. For example, the LLM may include a generative machine learning model such as a generative pre-trained transformer (GPT) model. In some examples, a variable (e.g., “μm answerable” or the like) may be encoded based on the predictive output of the LLM.

In some embodiments, the input document 406 is a data entity that describes one or more text inputs that provide evidence for a predictive output of the input question 404. The input document 406, for example, may include a closed set of evidence for answering the input question 404. The input document 406 may be input to a machine learning model with the input question to contain the answer to the input question to the evidence from the input document. the input document 406 may include a plurality of different units of text that are related to an input question 404. The extent and type of units of text may depend on the input question 404 and/or prediction domain associated with the input question 404. As one example, in a healthcare domain, the input document 406 may include clinical records for a patient, such as one or more radiology reports, clinical notes, or the like.

In some embodiments, the reference dataset 410 comprises a plurality of annotated question-answer pairs that comprises a plurality of reference questions, a plurality of reference answers, and a plurality of document contexts. In some embodiments, the reference dataset 410 is a data structure that describes a plurality of data objects for a prediction domain. An example reference dataset 410 may include any type (and any number) of data storage structures including, as examples, one or more linked lists, databases (e.g., relational databases, graph database, etc.), and/or the like. In some examples, the reference dataset 410 may include a training dataset for one or more machine learning models. For example, the reference dataset 410 may include a plurality of reference data objects, each reflective of an annotated question-answer pair for a prediction domain that may be used as a training entry and/or as an in-context prompt example for one or more different machine learning models of the present disclosure. In some examples, the reference dataset 410 may be domain specific. For instance, the reference dataset 410 may include a plurality of annotated question-answer pairs that are related to the particular prediction domain. As one example, in a healthcare domain, the reference dataset 410 may include annotated question-answer pairs from one or more healthcare domain fields, such as radiology, primary care, dermatology, and/or the like. In some embodiments, an annotated question-answer pair includes a reference question, a reference answer, and a reference document context (e.g., document context).

In some examples, the reference dataset 410 is leveraged to generate a generative model prompt for an LLM to output a predictive output for the input question 404 based on the corresponding input document 406. In some examples, the generative model prompt may include a few-shot prompt. For instance, one or more annotated question-answer pairs may be selected from the reference dataset 410 based on the input question 404 and/or corresponding input document 406 and included in a few-shot prompt as one or more in-context prompt examples. To improve model performance, in some examples, the one or more selected annotated question-answer pairs may be intelligently selected to include a combination of simple and complex annotated question-answer pairs. The annotated question-answer pairs may be selected using an in-context example selection mechanism 412.

In some embodiments, a simple annotated question-answer pair 422 is an annotated question-answer pair that is associated with a low measure of difficulty with respect to the input data object 402. In some examples, the simple annotated question-answer pair 422 may be randomly selected from a set of simple annotated question-answer pairs that are associated with a historically high performance of the LLM. The set of simple annotated question-answer pairs, for example, may include annotated question-answer pairs that are positively predicted during one or more training and/or validation operations of the LLM.

In addition, or alternatively, a simple annotated question-answer pair 422 may include an annotated question-answer pair that is semantically and/or syntactically similar to the input question 404 of the input data object 402. For instance, a simple annotated question-answer pair 422 may be output by an in-context example selection mechanism configured to identify and select one or more annotated question-answer pairs that are similar to the input data object 402. Any of a plurality of in-context example selection mechanisms may be leveraged to select a simple annotated question-answer pair 422. In some examples, a nearest neighbor-based selection mechanism 412A is leveraged to select the one or more simple annotated question-answer pairs 422 for the input question 404 based on an embedding similarity between one or more reference questions and the input question 404 of the input data object 402.

In some embodiments, an in-context example selection mechanism 412 is a prompt engineering subroutine configured to intelligently filter and select in-context examples for a generative model query. An in-context example selection mechanism 412 may include a data consultant agent routine (e.g., LLM agent model) that is configured to interact with an LLM to iteratively generate a model prompt for the LLM based on one or more prompt building criteria and/or an expected or actual performance of the LLM. For instance, an in-context example selection mechanism 412 may receive, as an input, the input question 404 and the input document 406 and provide, as an output, one or more annotated question-answer pairs that satisfy one or more prompt requirements associated with an LLM 450. Examples of in-context example selection mechanisms include nearest neighbor-based selection mechanism 412A, mistake-based selection mechanism 412B, question-context lexical overlap selection mechanism 412C, question-answer lexical overlap selection mechanism 412D, or the like

In some embodiments, the nearest neighbor-based selection mechanism 412A is an in-context example selection mechanism configured to select one or more simple annotated question-answer pairs for an input question. The nearest neighbor-based selection mechanism 412A may include identifying N reference questions (e.g., from a reference dataset) that are closest in embedding space to the input question, and selecting the N reference questions along with their corresponding reference answer and reference document to be included as in-context example in a generative model prompt.

For instance, a plurality of reference embeddings for a plurality of annotated question-answer pairs may be generated based on the plurality of reference questions from the plurality of annotated question-answer pairs. One or more simple annotated question-answer pairs may then be selected from the plurality of annotated question-answer pairs based on the output of one or more embedding similarity comparison techniques. The one or more embedding similarity comparison techniques, for example, may be configured to output a similarity measure for a respective reference embedding with respect to an input embedding for the input question. Examples of embedding similarity comparison techniques include a cosine similarity, Euclidean distance, and/or the like.

In some embodiments, a reference embedding is an encoded data entity (e.g., one or more vectors, etc.) that corresponds to a reference question from an annotated question-answer pair. A reference embedding may include any type of text embedding including Word2Vec, bidirectional encoder representations from transformers (BERT) embeddings, and/or the like. In some embodiments, a reference embedding may be generated using a pretrained encoder-only language model or other machine learning embedding models.

In some embodiments, an input embedding is an encoded data entity (e.g., one or more vectors, etc.) that corresponds to an input question. An input embedding may include any type of text embedding including Word2Vec, bidirectional encoder representations from transformers (BERT) embeddings, and/or the like. In some embodiments, an input embedding may be generated using a pretrained encoder-only language model or other machine learning embedding models.

In some embodiments, a machine learning embedding model is to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning embedding model may include any type of model configured, trained, and/or the like to generate an intermediate output, such as a feature embedding, for a unit of text. For example, a machine learning embedding model may be leveraged to generate a reference embedding for a reference question. As another example, a machine learning embedding model may be leveraged to generate an input embedding for an input question. A machine learning embedding model may include one or more of any type of machine learning model including one or more supervised, unsupervised, semi-supervised, reinforcement learning models, and/or the like. For instance, a machine learning embedding model may include a bidirectional transformer that may be trained using training data from a reference dataset to generate one or more domain specific embeddings for a prediction domain. In some embodiments, the machine learning embedding model includes a pretrained encoder-only language model.

In some embodiments, the pretrained encoder-only language model 414 is a type of machine learning embedding model. The pretrained encoder-only language model 414 may be previously trained using an unsupervised training technique and domain-specific training data. For instance, the pretrained encoder-only language model may be trained using a reference dataset associated with the prediction domain. In a healthcare domain, for example, the pretrained encoder-only model may be trained on a reference dataset comprising radiology-based question-answer pairs to generate reference embeddings and input embeddings that are leveraged (e.g., using nearest neighbor-based selection mechanism) to select simple annotated question-answer pairs for a radiology-based input question and corresponding radiology-based input document. In this manner, the pretrained encoder-only language model 414, trained using an unsupervised training technique and domain-specific training data, may provide improved performance relative to pretrained encoder-only language models (and other models) trained on generic text.

In some embodiments, one or more complex annotated question-answer pairs 424 is selected from the reference dataset 410. In some embodiments, the one or more complex annotated question-answer pairs 424 comprise a mistake prone annotated question-answer pair 424A associated with a failure question scenario of the LLM 450. In some embodiments, selecting the one or more complex annotated question-answer pairs comprises generating a response output for an annotated question-answer pair from the reference dataset by applying the LLM 450 to the annotated question-answer pair; identifying the failure question scenario based on the response output; and selecting the annotated question-answer pair as the mistake prone annotated question-answer pair 424A based on the failure question scenario.

In some embodiments, a mistake prone annotated question-answer pair 424A refers to an annotated question-answer pair associated with a failure question scenario with a particular LLM. For example, a mistake prone annotated question-answer pair may include an annotated question-answer pair having a reference question that the LLM 450 previously failed to answer (e.g., during one or more training and/or validation operations, etc.). For example, a reference question from an annotated question-answer pair may be previously included in a generative model prompt for the LLM 450. The annotated question-answer pair may be flagged as a mistake prone annotated question-answer pair in the event of a failure question scenario in which the LLM fails to output a predictive output that matches (e.g., within a threshold degree of similarity, etc.) the reference answer to the reference question. In such a case, the mistake prone annotated question-answer pair may be output from a mistake-based selection mechanism for the annotated question-answer pair.

In some embodiments, a failure question scenario is a data entity that describes an occurrence, where the output of an LLM fails to satisfy one or more predetermined criteria. In some embodiments, the predetermined criteria include a generation of a predictive output, by an LLM, to a reference question that matches a reference answer within a degree of similarity. For instance, a failure question scenario may define a semantic and/or syntactic similarity threshold (e.g., 80%, 90%, etc.). A failure question scenario may be identified in the event that a comparison between a predictive output and a reference answer fails to achieve the semantic and/or syntactic similarity threshold.

In some embodiments, a mistake-based selection mechanism 412B is a prompt engineering subroutine for selecting one or more mistake prone annotated question-answer pairs for an input data object. In some examples, the mistake-based selection mechanism 412B is configured to provide, via one or more generative model prompts, a plurality of reference questions from the reference dataset 410 to an LLM 450 to generate a response output (e.g., an answer span) for the plurality of reference questions. The mistake-based selection mechanism 412B may generate a set of mistake prone annotated question-answer pairs based on the performance of the LLM with respect to the plurality of reference questions. For instance, the plurality of reference questions may be provided as input to the LLM using any of a plurality of prompt templates, such as no-shot template (e.g., zero-shot prompt), random selection, or the like. The mistake-based selection approach identifies hard examples by including examples in the prompt which the LLM failed to answer. These examples may be sourced from the reference dataset and not the test data to avoid overfitting. This may require first applying the LLM to the reference dataset, optionally using other approaches to select in-context examples. Random selection or zero-inferences are examples of some of the approaches that can be used select-in context examples.

In some embodiments, the mistake-based selection mechanism 412B selects one or more mistake prone annotated question-answer pairs 424A from the set of mistake prone annotated question-answer pairs for the input data object 402. The one or more mistake prone annotated question-answer pairs 424A may be randomly sampled and/or selected based on a syntactic and/or semantic similarity with the input question 404 of the input data object 402. The one or more mistake prone annotated question-answer pairs 424A may be leveraged as in-context examples of a generative model prompt to the LLM 450.

In some embodiments, the one or more complex annotated question-answer pairs 424 comprise a context dissimilar question-answer pair 424B associated with a low question-context lexical overlap classification. In some embodiments, selecting the one or more complex annotated question-answer pairs comprises generating a similarity score for the annotated question-answer pair based on a count of n-grams in common between the reference question and the document context; generating a question-context lexical overlap classification for the annotated question-answer pair based on a comparison between the similarity score and a similarity threshold; and selecting the annotated question-answer pair as a complex annotated question-answer pair in response to the question-context lexical overlap classification comprising the low question-context lexical overlap classification.

In some embodiments, a context dissimilar question-answer pair 424B is an annotated question-answer pair with a low overlap between a respective reference question and reference document provided to answer the reference question. A context dissimilar question-answer pair 424B may be identified based on similarity score between the respective reference question and reference document. In some examples, a context dissimilar question-answer pair 424B may include an annotated question-answer pair with a similarity score that fails to satisfy a similarity threshold (e.g., 50%, 90%, 95%, etc.). A similarity score, for example, may be generated using a question-context lexical overlap selection mechanism 412C. For instance, a context dissimilar question-answer pair 424B may include an annotated question-answer pair that is assigned or otherwise associated with a low question-context lexical overlap based on a similarity score output of a question-context lexical overlap selection mechanism 412C. In this way, one or more in-context examples of an engineered prompt may include reference questions and answers that may help an LLM when it encounters similarly difficult input questions with low overlap with reference document.

In some embodiments, a question-context lexical overlap selection mechanism 412C is a prompt engineering subroutine for selecting one or more context dissimilar question-answer pairs for an input data object. The question-context lexical overlap selection mechanism 412C is configured to determine a question-context lexical overlap classification for an annotated question-answer pair using one or more natural language and/or embedding comparison techniques. For instance, a question-context lexical overlap classification may be based on an n-gram similarity between a reference question and reference document (e.g., document context). As an example, the question-context lexical overlap classification may be determined by determining a count of n-grams in common between the reference question and reference document associated with the reference question and generating a similarity score for the annotated question-answer pair based on the count of n-grams. The question-context lexical overlap selection mechanism 412C may be configured to assign a question-context lexical overlap classification to annotated question-answer pairs based on the similarity scores associated with a respective annotated question-answer pair and select one or more annotated question-answer pairs associated with a low question-context lexical overlap classification as context dissimilar question-answer pairs to be included in a few-shot prompt for an LLM. For example, an annotated question-answer pairs associated with a similarity score that fails to satisfy (e.g., below) a similarity threshold (e.g., 50%, 90%, 95%, etc.) may be assigned a low question-context lexical overlap classification, while annotated question-answer pairs associated with a similarity score that satisfies (e.g., equal to, above, or the like) the similarity threshold may be assigned a high question-context lexical overlap classification. In some embodiments, the question-context lexical overlap selection mechanism 412C selects one or more context dissimilar question-answer pairs 424B from a set of context dissimilar question-answer pairs for the input data object 402. The one or more context dissimilar question-answer pairs 424B may be randomly sampled and/or selected based on a syntactic and/or semantic similarity with the input question 404 of the input data object 402. The one or more context dissimilar question-answer pairs 424B may be leveraged as in-context examples of a generative model prompt to an LLM.

In some embodiments, the one or more complex annotated question-answer pairs 424 comprise an answer dissimilar question-answer pair 424C associated with a low question-answer overlap classification. In some embodiments, selecting the one or more complex annotated question-answer pairs comprises generating a similarity score for an annotated question-answer pair in the reference dataset based on a count of n-grams in common between the question and the answer in the annotated question-answer pair; generating a question-answer overlap classification for the annotated question-answer pair based on the similarity score; and selecting the annotated question-answer pair in response to determining that the annotated question-answer pair is associated with a low question-answer overlap classification.

In some embodiments, the answer dissimilar question-answer pair 424C is an annotated question-answer pair associated with a low overlap between a respective reference question and reference answer provided as the answer to the reference question. An answer dissimilar question-answer pair 424C may be identified based on similarity score between the respective reference question and reference answer. In some examples, an answer dissimilar question-answer pair 424C may include an annotated question answer pair with a similarity score that fails to satisfy a similarity threshold (e.g., 50%, 90%, 95%, etc.). A similarity score, for example, may be generated using a question-answer lexical overlap selection mechanism 412D. For instance, an answer dissimilar question-answer pair may include an annotated question-answer pair that is assigned or otherwise associated with a low question-answer lexical overlap based on a similarity score output of a question-answer lexical overlap selection mechanism 412D. In this way, one or more in-context examples of an engineered prompt may include reference questions and answers that may help an LLM when it encounters similarly difficult input questions with low overlap with the answer to the input question.

In some embodiments, a question-answer lexical overlap selection mechanism 412D is a prompt engineering subroutine for selecting one or more answer dissimilar question-answer pairs for an input data object. The question-answer lexical overlap selection mechanism is configured to determine a question-answer lexical overlap classification for an annotated question-answer pair using one or more natural language and/or embedding comparison techniques. For instance, a question-answer lexical overlap classification may be based on an n-gram similarity between a reference question and reference answer. As an example, the question-answer lexical overlap classification may be determined by determining a count of n-grams in common between the reference question and reference answer associated with the reference question and generating a similarity score for the annotated question-answer pair based on the count of n-grams. The question-answer lexical overlap selection mechanism may be configured to assign a question-answer lexical overlap classification to annotated question-answer pairs based on the similarity scores associated with a respective annotated question-answer pair and select one or more annotated question-answer pairs associated with a low question-answer lexical overlap classification as answer dissimilar question-answer pairs to be included in a generative model prompt. For example, an annotated question-answer pair associated with a similarity score that fails to satisfy (e.g., below) a similarity threshold (e.g., 50%, 90%, 95%, etc.) may be assigned a low question-answer lexical overlap classification while annotated question-answer pairs associated with a similarity score that satisfies (e.g., equal to, above, or the like) the similarity threshold may be assigned a high question-answer lexical overlap classification. In some embodiments, a question-answer lexical overlap selection mechanism 412D selects one or more answer dissimilar question-answer pairs 424C from a set of answer dissimilar question-answer pairs for the input data object 402. The one or more answer dissimilar question-answer pairs 424C may be randomly sampled and/or selected based on a syntactic and/or semantic similarity with the input question 404 of the input data object 402. The one or more answer dissimilar question-answer pairs 424C may be leveraged as in-context examples of a generative model prompt to the LLM 450.

In some embodiments, a few-shot prompt 428 is generated based on the one or more simple annotated question-answer pairs 422 and the one or more complex annotated question-answer pairs 424. In some embodiments, generating the few-shot prompt 428 based on the one or more simple annotated question-answer pairs 422 and the one or more complex annotated question-answer pairs 424 comprises generating the few-shot prompt 428 from a prompt template associated with the input question; modifying the few-shot prompt with the input document 406 or a reference to the input document 406; generating a plurality of in-context prompt examples by aggregating the one or more simple annotated question-answer pairs and the one or more complex annotated question-answer pairs; and modifying the few-shot prompt with the plurality of in-context prompt examples.

In some embodiments, the prompt template is a data entity that describes a predefined structure for a generative model prompt. The prompt template, for example, may include a no-shot prompt template, a few-shot prompt template, and/or the like. The prompt template may include one or more model-specific fields that may be tailored to a particular LLM. In addition, or alternatively, the prompt template may include one or more instruction sets for guiding an LLM for a particular generative task. In some examples, the instruction sets may be dynamically tailored and/or selected for a specific generative task. For instance, a prompt template may be selected from a plurality of prompt templates based on an efficacy of the template's instruction set for the specific generative task.

In some embodiments, the few-shot prompt 428 is provided to an LLM to receive a predictive output for the input question 404.

In some embodiments, a predictive output is a model output generated by the LLM 450 for the input data object 402. For example, the predictive output may include an answer span extracted from the input document 406 that answers the input question 404. The answer span, for example, may include a segment of text that reflects a portion of evidence from an input document that answers an input question. In some embodiments, a predictive output is generated by inputting a generative model prompt to the LLM 450. For instance, using one or more techniques of the present disclosure, a few-shot prompt 428 may be generated for the input data object 402. The few-shot prompt may include an input question, an input document, and one or more in-context prompt examples. The predictive output may include an answer to the input question 404 that is extracted from the input document 406 and formatted based on the one or more in-context prompt examples. In some examples, the predictive output may include one of a plurality of predictive outputs for the input data object 402 that may be refined, using some of the techniques of the present disclosure, by augmenting the few-shot prompt 428 provided to the LLM 450. For instance, the plurality of predictive outputs may include an initial predictive output and one or more updated predictive outputs that are iteratively refined using interactively augmented model prompts, as described herein.

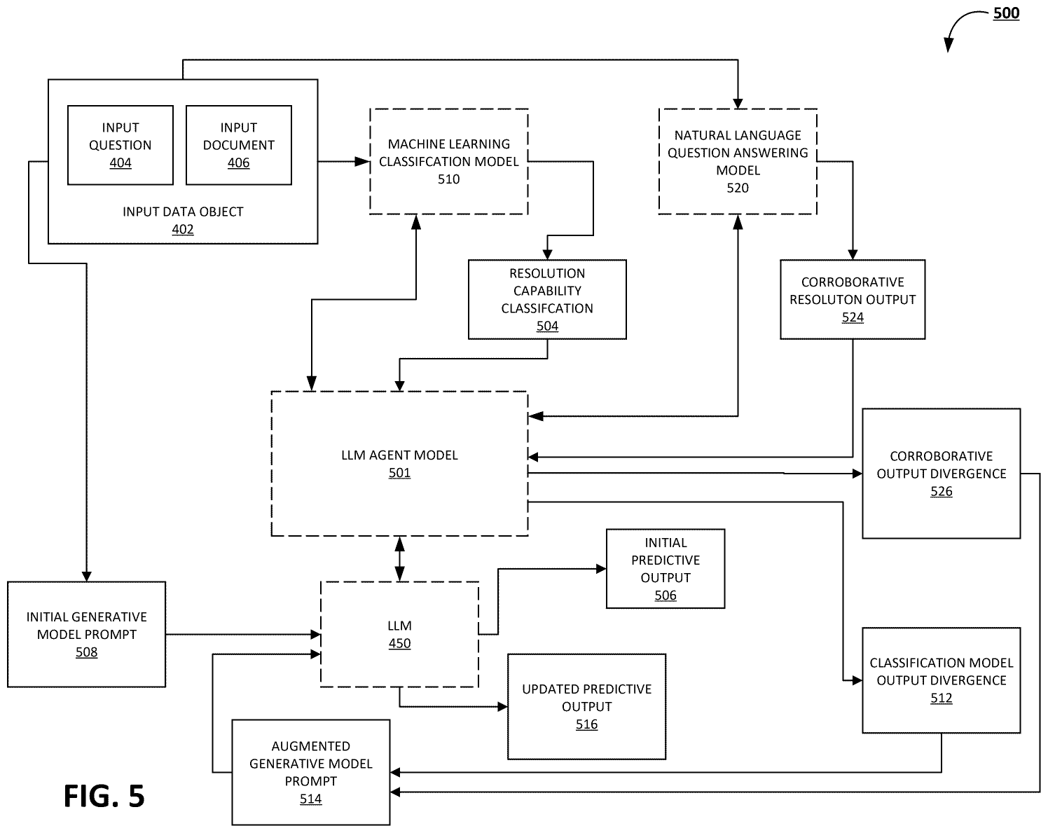

FIG. 5 is a dataflow diagram 500 showing example data structures and modules for an iterative, feedback-based generative framework in accordance with some embodiments discussed herein. The dataflow diagram 500, for example, illustrates a multi-stage iterative prompt refinement pipeline for incorporating outputs from collaborating models, the machine learning classification model 510 and the natural language question answering model 520, to both verify predictive outputs of the LLM 450 and iteratively augment the generative model prompts of the LLM 450. By doing so, the iterative, feedback-based generative techniques of the present disclosure improve the performance of LLM models, while providing failsafe verification mechanisms that directly address reliability challenges unique to LLM technology.

In some embodiments, a resolution capability classification 504 is generated for the input data object 402 using a machine learning classification model 510. In some embodiments, the machine learning classification model 510 comprises a language model. In some embodiments, the machine learning classification model 510 comprises a supervised machine learning model that is trained using the reference dataset 410 and a plurality of resolution capability training labels.

In some embodiments, an initial predictive output 506 is generated for the input data object 402 based on an initial generative model prompt 508 for the input data object and using the LLM 450. In some embodiments, a classification model output divergence 512 is identified based on a comparison between the resolution capability classification 504 and the initial predictive output 506. In some embodiments, in response to the classification model output divergence 512, an augmented generative model prompt 514 is generated by modifying the initial generative model prompt 508 with a representation of the resolution capability classification 504, and an updated predictive output 516 is generated based on the augmented generative model prompt 514 and using the LLM 450.

In some embodiments, the LLM 450 is communicatively connected to an LLM agent model 501. In some embodiments, one or more resolution capability iterations is performed using the LLM agent model 501. In some embodiments, the resolution capability classification 504 for the input data object 402 is generated during the first iteration and the classification model output divergence 512 comprises a first iteration classification model output divergence, and a second iteration comprises identifying a second iteration classification model output divergence based on a comparison between the resolution capability classification and the updated predictive output; modifying the augmented generative model prompt in response to the second iteration classification model output divergence; and performing another of the one or more resolution capability iterations.

In some embodiments, the LLM agent model 501 is configured to perform the one or more resolution capability iterations until a resolution capability stop condition is satisfied. In some embodiments, the resolution capability stop condition comprises a threshold number of one or more resolution capability iterations or a classification model output convergence. In some embodiments, the classification model output convergence is based on a match between a predictive output of the LLM 450 and the resolution capability classification 504.

In some embodiments, the LLM agent model 501 is a computer-implemented process for providing feedback to an LLM. For example, the LLM agent model 501 may be configured to provide feedback to the LLM 450 based on the output of a comparison of the predictive output (initial predictive output 506, updated predictive output 516) of the LLM 450 to a resolution capability classification 504 output of a machine learning classification model 510 and/or based on a comparison of the predictive output of the LLM 450 to a corroborative resolution output of a natural language question-answering model 520. The LLM agent model 501 may be configured to provide feedback to the LLM 450 via the generative model prompt (e.g., augmented generative model prompt, etc.). For example, the LLM agent model 501 may be configured to provide feedback to the LLM 450 by augmenting the generative model prompt for the LLM with text inputs. The text inputs, for example, may comprise representation of resolution capability classification outputs of one or more machine learning classification models and/or representations of corroborative resolution outputs of one or more natural language question-answering model.

In some examples, the LLM agent model 501 may be configured to perform one or more resolution capability iterations until a resolution capability stop condition is satisfied and provide feedback to the LLM 450 for each resolution capability iteration. In some examples, the resolution capability stop condition may be a threshold number of one or more resolution capability iterations (e.g., N maximum iterations, where N is an integer) or a classification model output convergence. By way, of example, if the model outputs after the threshold number of one or more resolution capability iterations still do not converge, a determination whether the input question is answerable may be based on a random determination or based on knowledge about the performance of the machine learning classification model 510 and/or LLM 450. In some examples, the LLM agent model 501 may be configured to perform one or more corroborative resolution iterations until a corroborative stop condition is satisfied and provide feedback to the LLM 450 for each corroborative resolution iteration. In some embodiments, the corroborative stop condition may be a threshold number of one or more corroborative resolution iterations (e.g., N maximum iterations, where N is an integer) or a corroborative output convergence.

In some embodiments, the initial generative model prompt is an initial prompt for instructing an LLM 450 to generate the initial predictive output 506. The initial generative model prompt 508 may include a few-shot prompt comprising a plurality of prompt examples (e.g., in-context examples). The initial generative model prompt 508, for example, may comprise the few-shot prompt 428. The initial generative model prompt 508 may be augmented to generate the augmented generative model prompt 514.

In some embodiments, the augmented generative model prompt 514 is a modified initial generative model prompt. By way of example, the augmented generative model prompt 514 may be generated by augmenting the initial generative model prompt 508 with one or more text inputs based on output of one or more machine learning models (e.g., one or more machine learning classification models 510, one or more natural language question-answering models 520, etc.).

In some embodiments, the classification model output divergence 512 is a data entity indicative of a discrepancy or otherwise disagreement between two model outputs. For instance, a classification model output divergence 512 may be indicative of a discrepancy/disagreement between the resolution capability classification 504 output of the machine learning classification model 510 and the predictive output (e.g., initial predictive output 506, updated predictive output 516) of the LLM 450. The LLM agent model 501 communicatively connected to the LLM 450 may be configured to augment the generative model prompt for the LLM 450 in response to the classification model output divergence 512.

In some embodiments, the machine learning classification model 510 is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. The machine learning classification model 510 may include any type of model configured, trained, and/or the like to generate a resolution capability classification for an input question. The machine learning classification model 510 may include one or more of any type of machine learning models including one or more supervised, unsupervised, semi-supervised, reinforcement learning models, and/or the like. The machine learning classification model 510 may be configured to receive an input question and input document corresponding to the input question and classify the input question based on the likelihood of the input question being answerable based on the input document. By way of example, the machine learning classification model may be previously trained to classify an input question into a predefined category using a reference dataset associated with the prediction domain. For example, during a training phase, the machine learning classification model may be trained to assign a positive resolution capability classification (e.g., label “1”) to a reference question if the reference question is answerable using the reference document or assign a negative resolution capability classification (e.g., label “0”) if the reference document is not answerable using the reference document. In some embodiments, the machine learning classification model 510 includes a language model. By way of example, in a healthcare domain, the machine learning classification model may include a BioClinicalROBERTa model that is finetuned on a clinical dataset, such as RadQA.

In some embodiments, the machine learning classification model is trained using one or more annotated question answer pairs from the reference dataset 410. For instance, the machine learning classification model may be trained using training entries in the form of:
<Question Text><SEP TOKEN><Document Context>”
   with 0 and 1 labels depending on whether the question in answerable from the document.

In some embodiments, the resolution capability classification 504 is a data entity that describes a machine learning classification model output. The resolution capability classification 504 may be indicative of whether the input question 404 from the input data object 402 is answerable based on the input document 406 associated with the input question 404. The resolution capability classification 504 may include a positive classification (e.g., label “1”) or a negative classification (e.g., label “0”). In some examples, a variable (e.g., “clf_answerable” or the like) may be encoded based on the resolution capability classification 504 for the input data object 402.

In some embodiments, a corroborative resolution output 524 is generated for the input data object 402 using a natural language question-answering model 520. In some embodiments, a corroborative output divergence 526 is identified based on a comparison between the corroborative resolution output 524 and the initial predictive output 50. In some embodiments, in response to the corroborative output divergence 526, an augmented generative model prompt 514 is generated by modifying the initial generative model prompt 508 with a representation of the corroborative resolution output 524.

In some embodiments, one or more corroborative resolution iterations is performed using the LLM agent model. In some embodiments, the corroborative resolution output for the input data object is generated during the first iteration and the corroborative output divergence comprises a first iteration corroborative output divergence. In some embodiments, a second iteration comprises identifying a second iteration corroborative output divergence based on a comparison between the corroborative resolution output and the updated predictive output; modifying the augmented generative model prompt 514 in response to the second iteration corroborative resolution output; and performing another of the one or more corroborative resolution iterations.

In some embodiments, the LLM agent model 501 is configured to perform the one or more corroborative resolution iterations until a corroborative resolution stop condition is satisfied. In some embodiments, the corroborative resolution stop condition comprises a threshold number of one or more corroborative resolution iterations or a corroborative output convergence. In some embodiments, the corroborative output divergence 526 is identified based on a corroborative similarity score between the corroborative resolution output 524 and the initial predictive output 506. In some embodiments, the corroborative similarity score is based on an n-gram similarity between the corroborative resolution output and the initial predictive output. In some embodiments, the corroborative similarity score is based on an embedding similarity between the corroborative resolution output and the initial predictive output.

In some embodiments, the corroborative resolution output 524 refers to a data entity that describes a natural language question-answering model output. The corroborative resolution output may comprise an answer to an input question as determined by a natural language question-answering model. The corroborative resolution output may be leveraged to provide feedback to an LLM.

In some embodiments, the natural language question-answering model 520 is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. The natural language question-answering model 520 may include any type of model configured, trained, and/or the like to generate a corroborative resolution output for an input question. The natural language question-answering model 520 may include one or more of any type of machine learning models including one or more supervised, unsupervised, semi-supervised, reinforcement learning models, and/or the like. The natural language question-answering model 520 may be configured to receive the input question 404 and input document 406 corresponding to the input question 404 and process to the input question 404 and input document 406 to generate the corroborative resolution output 524. By way of example, the natural language question-answering model 520 may be previously trained to generate a corroborative resolution output for an input data object using a reference dataset associated with the prediction domain. In some examples, the natural language question-answering model 520 is a fine-tuned natural language question-answering model.

In some embodiments, the natural language question-answering model 520 is configured to work similarly to the machine learning classification model 510 but configured to generate an answer to the input question 404 of the input data object 402 directly and provide the generated answer as feedback to the LLM 450. If the answer generated by the natural language question-answering model 520 is the same as that of the LLM 450 or substantially similar according to n-gram overlap similarity or embedding similarity of the corroborative resolution output (e.g., generated answer by the natural language question-answering model and generated answer by the LLM 450, then the natural language question-answering model and the LLM agree. If the answer generated by the natural language question-answering model is not the same as that of the LLM 450 or not substantially similar according to n-gram overlap similarity or embedding similarity of the corroborative resolution output, feedback may be provided to the LLM 450 in a similar manner as described above with respect to the machine learning classification model 510. For instance, the corroborative resolution output (e.g., answer to the input question) from the fine-tuned natural language question-answering model or other question-answering model may be provided in a generative model prompt for the LLM 450 as follows: “You provided response X to question Q but another natural language question-answering model provided response Y. Based on this feedback, please produce a new response to the question based on the reference document.” In this regard, the LLM can then integrate this feedback to produce an improved response.

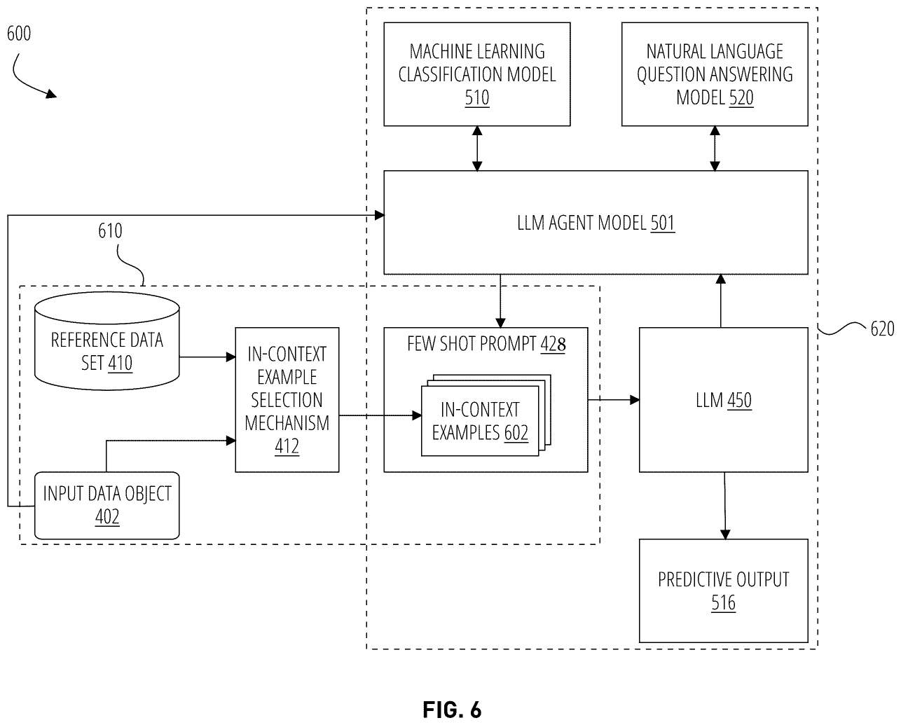

FIG. 6 is a dataflow diagram 600 showing example data structures and modules for an end-to-end prompt engineering and interactive feedback-based generative framework in accordance with some embodiments discussed herein. As depicted, the end-to-end prompt engineering and interactive feedback-based generative framework may include two complementary stages, an initial prompt engineering stage 610 and an iterative feedback-based generative output stage 620. In some examples, the initial prompt engineering stage 610 may be configured to generate a few-shot prompt 428 for use as a basis by the iterative feedback-based generative output stage 620. During the iterative feedback-based generative output stage 620, the few-shot prompt 428 may be input to an LLM 450 and then iteratively refined until the LLM 450 produces a predictive output 516 that satisfies one or more verification criteria.

More particularly, during the initial prompt engineering stage 610, an input data object 402 may be compared, using an in-context example selection mechanism, to a reference dataset 410 to extract a plurality of in-context examples 602 for the input data object. As described herein, the in-context examples 602 may include an aggregation of a plurality of prompt examples individually extracted by one of a plurality of different prompt engineering techniques. The in-context examples 602 may be incorporated to a prompt template to generate an initial few-shot prompt 428.

During the iterative feedback-based generative output stage 620, the initial few-shot prompt 428 may be provided as an input to the LLM 450 to receive an intermediate predictive output. The intermediate predictive output may be provided to an LLM agent model 501 for a comparison to one or more complementary model outputs for the input data object 402. As described herein, in some examples, the LLM agent model 501 may perform a step-wise verification process in which the intermediate predictive output is compared to the output of a first model over a plurality of first iterations until a convergence is reached (and/or stop after a stopping condition is reached (e.g., three iterations, etc.)) and, once the convergence is reached, the intermediate predictive output is compared to the output of a second model for a plurality of second iterations until a convergence is reached (and/or stop after a stopping condition is reached (e.g., three iterations, etc.)). In addition, or alternatively, the LLM agent model 501 may perform a parallel verification process in which the intermediate predictive output is compared to the output of a first model and second model in parallel until a convergence is reached and/or a stopping condition is reached (e.g., three iterations, etc.)).

The verification process may leverage any number of models, including the machine learning classification model 510 and/or the natural language question answering model 520. In response a divergence between an intermediate output and an output of the complementary models, the initial few-shot prompt 428, provided as a basis through the initial prompt engineering stage 610, may be augmented with the intermediate output, the output of the divergent model, and a template explaining the divergence. In this way, the few-shot prompt 428 may be iteratively fine tunes across a plurality of verification iterations until reliable predictive output is achieved.

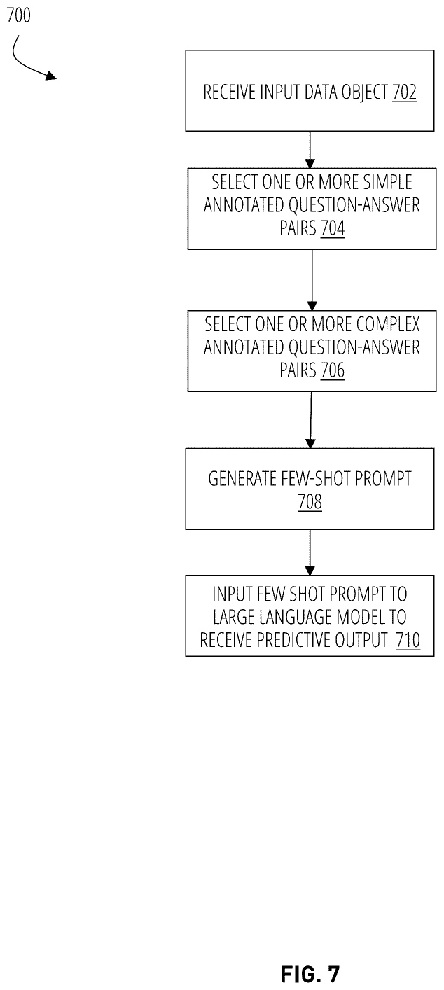

FIG. 7 is a flowchart diagram of an example process 700 for implementing a prompt engineering framework in accordance with some embodiments discussed herein. The flowchart depicts a multi-stage prompt engineering process 700 for generating improved generative model prompts that are tailored to a diverse array of LLM inputs and designed to improve LLM performance with respect various predictive tasks. The process 700 may be implemented by one or more computing devices, entities, and/or systems described herein. For example, via the various steps/operations of the process 700, the computing system 101 may leverage improved prompt engineering and selection techniques to generate a few-shot prompt for an LLM that is specially tailored to address technical challenges observed in LLM technology. By doing so, the process 700 facilitates prompt engineering techniques that are directly tailored to addressing technical challenges, such as reliability, lack of comprehensive reference data, and/or the like, unique to LLM technology.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, receiving an input data object. For example, the computing system 101 may receive the input data object. In some examples, the input data object may include an input question and an input document.

In some embodiments, the process 700 includes, at step/operation 704, selecting one or more simple annotated question-answer pairs for the input data object. For example, the computing system 101 may select the one or more simple annotated question-answer pairs from a reference dataset.

In some embodiments, the reference dataset includes a plurality of annotated question-answer pairs that comprise a plurality of reference questions, a plurality of reference answers, and a plurality of reference document contexts. In some examples, the computing system 101 may select the one or more simple annotated question-answer pairs by generating, using a pretrained encoder-only language model, a plurality of reference embeddings for the plurality of annotated question-answer pairs based on the plurality of reference questions. The computing system 101 may generate, using the pretrained encoder-only language model, an input embedding based on the input question and select, using a nearest neighbor-based selection mechanism, the one or more simple annotated question-answer pairs based on an embedding similarity between the input embedding and the plurality of reference questions. In some embodiments, the pretrained encoder-only language model is previously trained using an unsupervised training technique and the reference dataset.

In some embodiments, the process 700 includes, at step/operation 706, selecting one or more complex annotated question-answer pairs. For example, the computing system 101 may select the one or more complex annotated question-answer pairs from the reference dataset. In some embodiments, the one or more complex annotated question-answer pairs include a mistake prone annotated question-answer pair associated with a failure question scenario of the LLM. For example, the computing system 101 may select the one or more complex annotated question-answer pairs by generating a response output for an annotated question-answer pair from the reference dataset by applying the LLM to the annotated question-answer pair. The computing system 101 may identify the failure question scenario based on the response output and select the annotated question-answer pair as the mistake prone annotated question-answer pair based on the failure question scenario.

In some embodiments, the one or more complex annotated question-answer pairs include a context dissimilar question-answer pair associated with a low question-context lexical overlap classification. For example, the computing system 101 may select the one or more complex annotated question-answer pairs by generating a similarity score for the annotated question-answer pair based on a count of n-grams in common between the reference question and the document context. The computing system 101 may generate a question-context lexical overlap classification for the annotated question-answer pair based on a comparison between the similarity score and a similarity threshold and select the annotated question-answer pair as a complex annotated question-answer pair in response to the question-context lexical overlap classification including the low question-context lexical overlap classification.

In some embodiments, the one or more complex annotated question-answer pairs include an answer dissimilar question-answer pair associated with a low question-answer overlap classification. For example, the computing system 101 may select the one or more complex annotated question-answer pairs by generating a similarity score for an annotated question-answer pair in the reference dataset based on a count of n-grams in common between the question and the answer in the annotated question-answer pair. The computing system 101 may generate a question-answer overlap classification for the annotated question-answer pair based on the similarity score and select the annotated question-answer pair in response to determining that the annotated question-answer pair is associated with a low question-answer overlap classification.

In some embodiments, the process 700 includes, at step/operation 708, generating a few-shot prompt. For example, the computing system 101 may generate the few-shot prompt based on the one or more simple annotated question-answer pairs and/or the one or more complex annotated question-answer pairs.

In some embodiments, the process 700 includes, at step/operation 710, providing the few-shot prompt. For example, the computing system 101 may provide the few-shot prompt to an LLM to receive a predictive output for the input question. For example, the computing system 101 may generate the few-shot prompt from a prompt template associated with the input question. The computing system 101 may modify the few-shot prompt with the input document or a reference to the input document and generate a plurality of in-context prompt examples by aggregating the one or more simple annotated question-answer pairs and the one or more complex annotated question-answer pairs. The computing system 101 may modify the few-shot prompt with the plurality of in-context prompt examples.

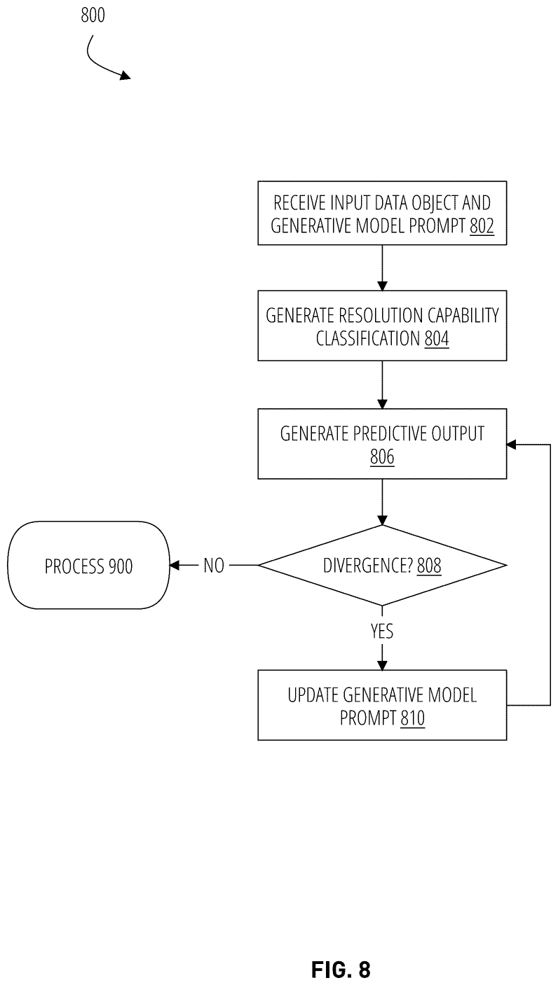

FIG. 8 is a flowchart diagram of an example process 800 for implementing a first stage of an iterative, feedback-based generative framework in accordance with some embodiments discussed herein. The flowchart depicts a first stage of a multi-stage iterative, feedback-based generative framework for improving the performance and reliability of LLM technology. The process 800 may be implemented by one or more computing devices, entities, and/or systems described herein. For example, via the various steps/operations of the process 800, the computing system 101 may leverage an improved LLM pipeline to iteratively refine outputs of an LLM based on the outputs a plurality of complementary models. In the first stage depicted by the example process 800, the complementary model may include a resolution capability classification model that is configured to identify whether the evidence provided with a document is sufficient to answer an input question. By doing so, the process 800 directly addresses a technical challenge unique to LLM technology (e.g., unanswerable questions that require inaccurate hallucinations to answer) by detecting unanswerable questions historically hidden by LLM propensities to hallucinate.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes, at step/operation 802, receiving an input data object and generative model prompt. For example, the computing system 101 may receive the input data object and a generative model prompt for the input data object. The input data object, for example, may include an input question and an input document. The generative model prompt may include a prompt to answer the input question based on evidence from the input document.

In some embodiments, the process 800 includes, at step/operation 804, generating a resolution capability classification for an input data object. For example, the computing system 101 may generate, using a machine learning classification model, a resolution capability classification for the input data object. In some embodiments, the machine learning classification model includes a language model. In some examples, the machine learning classification model may include a supervised machine learning model that is trained using the reference dataset and a plurality of resolution capability training labels.

In some embodiments, the process 800 includes, at step/operation 806, generating an initial predictive output for the input data object. For example, the computing system 101 may generate, using an LLM, an initial predictive output for the input data object based on the initial generative model prompt for the input data object. For example, the computing system 101 may input the initial generative model prompt to the LLM to receive the initial predictive output as an output of the LLM.

In some embodiments, the process 800 includes, at step/operation 808, identifying a classification model output divergence. For example, the computing system 101 may identify a classification model output divergence based on a comparison between the resolution capability classification and the initial predictive output. In response to a divergence, the process 800 may proceed to step/operation 810 to perform another iteration. In response to a convergence, the process 800 may proceed to process 900 to perform a second stage of the multi-stage iterative, feedback-based generative framework.

In some embodiments, the process 800 includes, at step/operation 810, updating the generative model prompt. For example, the computing system 101 may update the generative model prompt based on the divergence of the predictive output from the resolution capability classification. For example, the computing system 101 may, in response to the classification model output divergence, generate an augmented generative model prompt by modifying the initial generative model prompt with a representation of the resolution capability classification. The computing system 101 may perform a second iteration of the process 800 with the augmented generative model prompt. For example, the computing system 101 may return to step/operation 806 and generate, using the LLM, an updated predictive output based on the augmented generative model prompt.

In some embodiments, the computing system 101 implements an LLM agent model that is communicatively connected to the LLM. The computing system 101 may trigger the performance of one or more resolution capability iterations using the LLM agent model. For example, the computing system 101 may perform, using an LLM agent model, one or more resolution capability iterations. In some embodiments, the computing system 101 may generate a resolution capability classification for the input data object during the first iteration and the classification model output divergence may include a first iteration classification model output divergence. A second iteration may include identifying a second iteration classification model output divergence based on a comparison between the resolution capability classification and the updated predictive output, modifying the augmented generative model prompt in response to the second iteration classification model output divergence, and performing another of the one or more resolution capability iterations. For example, the LLM agent model may be configured to perform the one or more resolution capability iterations until a resolution capability stop condition is satisfied. In some embodiments, the resolution capability stop condition comprises a threshold number of one or more resolution capability iterations or a classification model output convergence. In some embodiments, the classification model output convergence is based on a match between a predictive output of the LLM and the resolution capability classification.

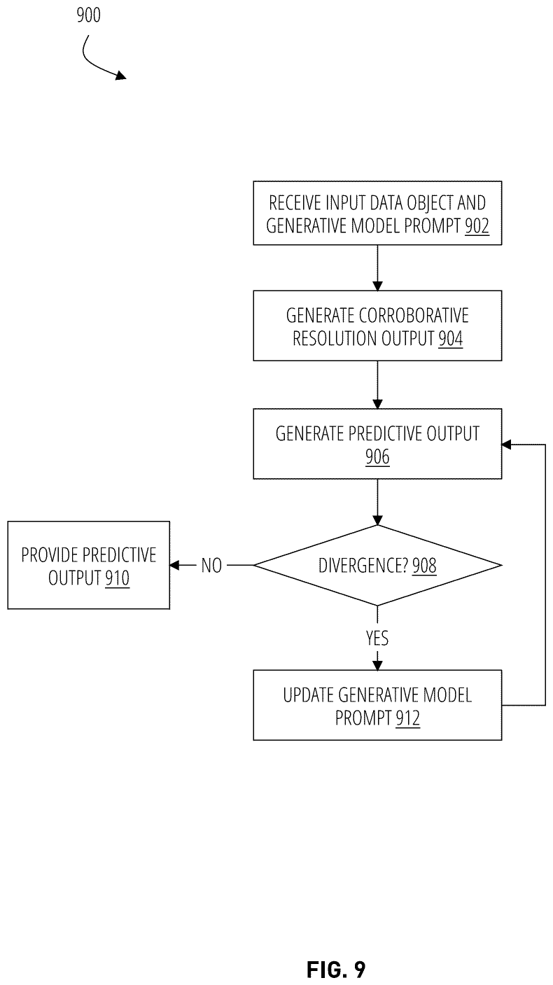

FIG. 9 is a flowchart diagram of an example process 900 for implementing a second stage of an iterative, feedback-based generative framework in accordance with some embodiments discussed herein. The flowchart depicts a second stage of a multi-stage iterative, feedback-based generative framework for improving the performance and reliability of LLM technology. The process 900 may be implemented by one or more computing devices, entities, and/or systems described herein. For example, via the various steps/operations of the process 900, the computing system 101 may leverage an improved LLM pipeline to iteratively refine outputs of an LLM based on the outputs a plurality of complementary models. In the second stage depicted by the example process 900, the complementary model may include a natural language question-answering model that is configured to generate a corroboration answer for an input question. By doing so, the process 900 directly addresses a technical challenge unique to LLM technology (e.g., unreliable answers, etc.) by cross-referencing the outputs of an LLM with other models with better accuracy at the expense of readability and other benefits provided by LLM technology.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 includes, at step/operation 902, receiving an input data object and generative model prompt. For example, the computing system 101 may receive the input data object and a generative model prompt for the input data object. The input data object, for example, may include an input question and an input document. The generative model prompt may include a prompt to answer the input question based on evidence from the input document. In some examples, the generative model prompt may include an augmented generative model prompt that is augmented in a previous stage of the multi-stage iterative, feedback-based generative framework.

In some embodiments, the process 900 includes, at step/operation 904, generating a corroborative resolution output for the input data object. For example, the computing system 101 may generate, using a natural language question-answering model, a corroborative resolution output for the input data object.

In some embodiments, the process 900 includes, at step/operation 906, generating an initial predictive output for the input data object. For example, the computing system 101 may generate, using an LLM, an initial predictive output for the input data object based on the generative model prompt for the input data object. For example, the computing system 101 may input the generative model prompt to the LLM to receive the initial predictive output as an output of the LLM.

In some embodiments, the process 900 includes, at step/operation 908, identifying a corroborative output divergence. For example, the computing system 101 may identify a corroborative output divergence based on a comparison between the corroborative resolution output and the initial predictive output. In some embodiments, the corroborative output divergence is identified based on a corroborative similarity score between the corroborative resolution output and the initial predictive output. In some embodiments, the corroborative similarity score is based on an n-gram similarity between the corroborative resolution output and the initial predictive output. In some embodiments, the corroborative similarity score is based on an embedding similarity between the corroborative resolution output and the initial predictive output.

In response to a divergence, the process 900 may proceed to step/operation 912 to perform another iteration. In response to a convergence, the process 900 may proceed to process 910 to output the initial predictive output as a validated output.

In some embodiments, the process 900 includes, at step/operation 912, updating the generative model prompt. For example, the computing system 101 may update the generative model prompt based on the divergence of the initial predictive output from the corroborative resolution output. For example, the computing system 101 may, in response to the corroborative resolution output divergence, generate an augmented generative model prompt by modifying the generative model prompt with a representation of the corroborative resolution output. The computing system 101 may perform a second iteration of the process 900 with the augmented generative model prompt. For example, the computing system 101 may return to step/operation 906 and generate, using the LLM, an updated predictive output based on the augmented generative model prompt.

The computing system 101 may perform, using the LLM agent model, one or more corroborative resolution iterations. In some embodiments, the corroborative resolution output for the input data object is generated during the first iteration and the corroborative output divergence includes a first iteration corroborative output divergence, and a second iteration comprises identifying a second iteration corroborative output divergence based on a comparison between the corroborative resolution output and the updated predictive output, modifying the augmented generative model prompt in response to the second iteration corroborative resolution output, and performing another of the one or more corroborative resolution iterations. In some embodiments, the LLM agent model is configured to perform the one or more corroborative resolution iterations until a corroborative resolution stop condition is satisfied. The corroborative resolution stop condition may comprise a threshold number of one or more corroborative resolution iterations or a corroborative output convergence. Some techniques of the present disclosure enable the generation of action outputs that may be performed to initiate one or more real world actions to achieve real-world effects. The techniques of the present disclosure may be used, applied, and/or otherwise leveraged to generate predictive outputs, handle queries, and/or the like, which may help in various downstream tasks. For instance, the techniques of the present disclosure may facilitate automated verifications that may trigger the performance of actions at a client device, such as the display, transmission, and/or the like of data reflective of a verification in accordance with an answer to an input question. In some embodiments, a verification and/or answer associated therewith may trigger an alert of an approval, recommendation, and/or the like for a contextual scenario associated with an input question. The alert may be automatically communicated to a user associated with the input question.

In some examples, the computing tasks may include actions that may be based on a prediction domain. A prediction domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising generating, by one or more processors and using a machine learning classification model, a resolution capability classification for an input data object that comprises an input question and an input document; generating, by the one or more processors and using a large language model (LLM), an initial predictive output for the input data object based on an initial generative model prompt for the input data object; identifying, by the one or more processors, a classification model output divergence based on a comparison between the resolution capability classification and the initial predictive output; and in response to the classification model output divergence: generating an augmented generative model prompt by modifying the initial generative model prompt with a representation of the resolution capability classification, and generating, using the LLM, an updated predictive output based on the augmented generative model prompt.

Example 2. The computer-implemented method of example 1, wherein the LLM is communicatively connected to an LLM agent model and the computer-implemented method further comprises performing, using the LLM agent model, one or more resolution capability iterations, wherein: (i) the resolution capability classification for the input data object is generated during the first iteration and the classification model output divergence comprises a first iteration classification model output divergence, and (ii) a second iteration comprises: (a) identifying a second iteration classification model output divergence based on a comparison between the resolution capability classification and the updated predictive output, (b) modifying the augmented generative model prompt in response to the second iteration classification model output divergence, and (c) performing another of the one or more resolution capability iterations.

Example 3. The computer-implemented method of example 2, wherein the LLM agent model is configured to perform the one or more resolution capability iterations until a resolution capability stop condition is satisfied and the resolution capability stop condition comprises (i) a threshold number of one or more resolution capability iterations or (ii) a classification model output convergence.

Example 4. The computer-implemented method of example 3, wherein the classification model output convergence is based on a match between a predictive output of the LLM and the resolution capability classification.

Example 5. The computer-implemented method of any of the above examples, further comprising generating, using a natural language question-answering model, a corroborative resolution output for the input data object; identifying a corroborative output divergence based on a comparison between the corroborative resolution output and the initial predictive output; and in response to the corroborative output divergence, generating the augmented generative model prompt by modifying the initial generative model prompt with a representation of the corroborative resolution output.

Example 6. The computer-implemented method of example 5, wherein the LLM is communicatively connected to an LLM agent model and the computer-implemented method further comprises performing, using the LLM agent model, one or more corroborative resolution iterations, wherein: (i) the corroborative resolution output for the input data object is generated during the first iteration and the corroborative output divergence comprises a first iteration corroborative output divergence, and (ii) a second iteration comprises: (a) identifying a second iteration corroborative output divergence based on a comparison between the corroborative resolution output and the updated predictive output, (b) modifying the augmented generative model prompt in response to the second iteration corroborative resolution output, and (c) performing another of the one or more corroborative resolution iterations.

Example 7. The computer-implemented method of example 6, wherein the LLM agent model is configured to perform the one or more corroborative resolution iterations until a corroborative resolution stop condition is satisfied and the corroborative resolution stop condition comprises (i) a threshold number of one or more corroborative resolution iterations or (ii) a corroborative output convergence.

Example 8. The computer-implemented method of example 6, wherein the corroborative output divergence is identified based on a corroborative similarity score between the corroborative resolution output and the initial predictive output.

Example 9. The computer-implemented method of example 8, wherein the corroborative similarity score is based on an n-gram similarity between the corroborative resolution output and the initial predictive output.

Example 10. The computer-implemented method of example 8, wherein the corroborative similarity score is based on an embedding similarity between the corroborative resolution output and the initial predictive output.

Example 11. The computer-implemented method of any of the above examples, wherein the machine learning classification model comprises a language model.

Example 12. The computer-implemented method of any of the above examples, wherein the machine learning classification model comprises a supervised machine learning model that is trained using a reference dataset and a plurality of resolution capability training labels.

Example 13. A computing system comprising memory and one or more processors communicatively coupled to the memory, the one or more processors configured to generate, using a machine learning classification model, a resolution capability classification for an input data object that comprises an input question and an input document; generate, using an LLM, an initial predictive output for the input data object based on an initial generative model prompt for the input data object; identify a classification model output divergence based on a comparison between the resolution capability classification and the initial predictive output; and in response to the classification model output divergence: generate an augmented generative model prompt by modifying the initial generative model prompt with a representation of the resolution capability classification, and generate, using the LLM, an updated predictive output based on the augmented generative model prompt.

Example 14. The computing system of example 13, wherein the LLM is communicatively connected to an LLM agent model and the one or more processors are further configured to perform, using the LLM agent model, one or more resolution capability iterations, wherein: (i) the resolution capability classification for the input data object is generated during the first iteration and the classification model output divergence comprises a first iteration classification model output divergence, and (ii) a second iteration comprises: (a) identifying a second iteration classification model output divergence based on a comparison between the resolution capability classification and the updated predictive output, (b) modifying the augmented generative model prompt in response to the second iteration classification model output divergence, and (c) performing another of the one or more resolution capability iterations.

Example 15. The computing system of example 14, wherein the LLM agent model is configured to perform the one or more resolution capability iterations until a resolution capability stop condition is satisfied and the resolution capability stop condition comprises (i) a threshold number of one or more resolution capability iterations or (ii) a classification model output convergence.

Example 16. The computing system of example 15, wherein the classification model output convergence is based on a match between a predictive output of the LLM and the resolution capability classification.

Example 17. The computing system of examples 13-16, wherein the one or more processors are further configured to: generate, using a natural language question-answering model, a corroborative resolution output for the input data object; identifying a corroborative output divergence based on a comparison between the corroborative resolution output and the initial predictive output; and in response to the corroborative output divergence, generate the augmented generative model prompt by modifying the initial generative model prompt with a representation of the corroborative resolution output.

Example 18. The computing system of example 17, wherein the LLM is communicatively connected to an LLM agent model and the one or more processors are further configured to perform, using the LLM agent model, one or more corroborative resolution iterations, wherein: (i) the corroborative resolution output for the input data object is generated during the first iteration and the corroborative output divergence comprises a first iteration corroborative output divergence, and (ii) a second iteration comprises: (a) identifying a second iteration corroborative output divergence based on a comparison between the corroborative resolution output and the updated predictive output, (b) modifying the augmented generative model prompt in response to the second iteration corroborative resolution output, and (c) performing another of the one or more corroborative resolution iterations.

Example 19. The computing system of example 18, wherein the LLM agent model is configured to perform the one or more corroborative resolution iterations until a corroborative resolution stop condition is satisfied and the corroborative resolution stop condition comprises (i) a threshold number of one or more corroborative resolution iterations or (ii) a corroborative output convergence.

Example 20. One or more non-transitory computer-readable storage media including instructions that, when executed by one or more processors, cause the one or more processors to generate, using a machine learning classification model, a resolution capability classification for an input data object that comprises an input question and an input document; generate, using an LLM, an initial predictive output for the input data object based on an initial generative model prompt for the input data object; identify a classification model output divergence based on a comparison between the resolution capability classification and the initial predictive output; and in response to the classification model output divergence: generate an augmented generative model prompt by modifying the initial generative model prompt with a representation of the resolution capability classification, and generate, using the LLM, an updated predictive output based on the augmented generative model prompt.

Example 21. The computer-implemented method of example 1, wherein the method further comprises training the machine learning classification model and the LLM.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computing system of example 12, wherein the one or more processors are further configured to train the machine learning classification model and the LLM.

Example 25. The computing system of example 24, wherein the one or more processors are included in a first computing entity; and the machine learning classification model and the LLM is trained by one or more other processors included in a second computing entity.

Example 26. The one or more non-transitory computer-readable storage media of example 19, wherein the instructions further cause the one or more processors to train the machine learning classification model and the LLM.

Example 27. The one or more non-transitory computer-readable storage media of example 26, wherein the one or more processors are included in a first computing entity; and the machine learning classification model and the LLM are trained by one or more other processors included in a second computing entity.

1. A computer-implemented method comprising:
generating, by one or more processors and using a machine learning classification model, a resolution capability classification for an input data object that comprises an input question and an input document;
generating, by the one or more processors and using a large language model (LLM), an initial predictive output for the input data object based on an initial generative model prompt for the input data object;
identifying, by the one or more processors, a classification model output divergence based on a comparison between the resolution capability classification and the initial predictive output; and
in response to the classification model output divergence:
generating an augmented generative model prompt by modifying the initial generative model prompt with a representation of the resolution capability classification, and
generating, using the LLM, an updated predictive output based on the augmented generative model prompt.

2. The computer-implemented method of claim 1, wherein the LLM is communicatively connected to an LLM agent model and the computer-implemented method further comprises performing, using the LLM agent model, one or more resolution capability iterations, wherein:
(i) the resolution capability classification for the input data object is generated during the first iteration and the classification model output divergence comprises a first iteration classification model output divergence, and
(ii) a second iteration comprises: (a) identifying a second iteration classification model output divergence based on a comparison between the resolution capability classification and the updated predictive output, (b) modifying the augmented generative model prompt in response to the second iteration classification model output divergence, and (c) performing another of the one or more resolution capability iterations.

3. The computer-implemented method of claim 2, wherein the LLM agent model is configured to perform the one or more resolution capability iterations until a resolution capability stop condition is satisfied and the resolution capability stop condition comprises (i) a threshold number of one or more resolution capability iterations or (ii) a classification model output convergence.

4. The computer-implemented method of claim 3, wherein the classification model output convergence is based on a match between a predictive output of the LLM and the resolution capability classification.

5. The computer-implemented method of claim 1, further comprising:
generating, using a natural language question-answering model, a corroborative resolution output for the input data object;
identifying a corroborative output divergence based on a comparison between the corroborative resolution output and the initial predictive output; and
in response to the corroborative output divergence, generating the augmented generative model prompt by modifying the initial generative model prompt with a representation of the corroborative resolution output.

6. The computer-implemented method of claim 5, wherein the LLM is communicatively connected to an LLM agent model and the computer-implemented method further comprises performing, using the LLM agent model, one or more corroborative resolution iterations, wherein:
(i) the corroborative resolution output for the input data object is generated during the first iteration and the corroborative output divergence comprises a first iteration corroborative output divergence, and
(ii) a second iteration comprises: (a) identifying a second iteration corroborative output divergence based on a comparison between the corroborative resolution output and the updated predictive output, (b) modifying the augmented generative model prompt in response to the second iteration corroborative resolution output, and (c) performing another of the one or more corroborative resolution iterations.

7. The computer-implemented method of claim 6, wherein the LLM agent model is configured to perform the one or more corroborative resolution iterations until a corroborative resolution stop condition is satisfied and the corroborative resolution stop condition comprises (i) a threshold number of one or more corroborative resolution iterations or (ii) a corroborative output convergence.

8. The computer-implemented method of claim 6, wherein the corroborative output divergence is identified based on a corroborative similarity score between the corroborative resolution output and the initial predictive output.

9. The computer-implemented method of claim 8, wherein the corroborative similarity score is based on an n-gram similarity between the corroborative resolution output and the initial predictive output.

10. The computer-implemented method of claim 8, wherein the corroborative similarity score is based on an embedding similarity between the corroborative resolution output and the initial predictive output.

11. The computer-implemented method of claim 1, wherein the machine learning classification model comprises a language model.

12. The computer-implemented method of claim 1, wherein the machine learning classification model comprises a supervised machine learning model that is trained using a reference dataset and a plurality of resolution capability training labels.

13. A computing system comprising memory and one or more processors communicatively coupled to the memory, the one or more processors configured to:
generate, using a machine learning classification model, a resolution capability classification for an input data object that comprises an input question and an input document;
generate, using an LLM, an initial predictive output for the input data object based on an initial generative model prompt for the input data object;
identify a classification model output divergence based on a comparison between the resolution capability classification and the initial predictive output; and
in response to the classification model output divergence:
generate an augmented generative model prompt by modifying the initial generative model prompt with a representation of the resolution capability classification, and
generate, using the LLM, an updated predictive output based on the augmented generative model prompt.

14. The computing system of claim 13, wherein the LLM is communicatively connected to an LLM agent model and the one or more processors are further configured to perform, using the LLM agent model, one or more resolution capability iterations, wherein:
(i) the resolution capability classification for the input data object is generated during the first iteration and the classification model output divergence comprises a first iteration classification model output divergence, and
(ii) a second iteration comprises: (a) identifying a second iteration classification model output divergence based on a comparison between the resolution capability classification and the updated predictive output, (b) modifying the augmented generative model prompt in response to the second iteration classification model output divergence, and (c) performing another of the one or more resolution capability iterations.

15. The computing system of claim 14, wherein the LLM agent model is configured to perform the one or more resolution capability iterations until a resolution capability stop condition is satisfied and the resolution capability stop condition comprises (i) a threshold number of one or more resolution capability iterations or (ii) a classification model output convergence.

16. The computing system of claim 15, wherein the classification model output convergence is based on a match between a predictive output of the LLM and the resolution capability classification.

17. The computing system of claim 13, wherein the one or more processors are further configured to:
generate, using a natural language question-answering model, a corroborative resolution output for the input data object;
identifying a corroborative output divergence based on a comparison between the corroborative resolution output and the initial predictive output; and
in response to the corroborative output divergence, generate the augmented generative model prompt by modifying the initial generative model prompt with a representation of the corroborative resolution output.

18. The computing system of claim 17, wherein the LLM is communicatively connected to an LLM agent model and the one or more processors are further configured to perform, using the LLM agent model, one or more corroborative resolution iterations, wherein:
(i) the corroborative resolution output for the input data object is generated during the first iteration and the corroborative output divergence comprises a first iteration corroborative output divergence, and
(ii) a second iteration comprises: (a) identifying a second iteration corroborative output divergence based on a comparison between the corroborative resolution output and the updated predictive output, (b) modifying the augmented generative model prompt in response to the second iteration corroborative resolution output, and (c) performing another of the one or more corroborative resolution iterations.

19. The computing system of claim 18, wherein the LLM agent model is configured to perform the one or more corroborative resolution iterations until a corroborative resolution stop condition is satisfied and the corroborative resolution stop condition comprises (i) a threshold number of one or more corroborative resolution iterations or (ii) a corroborative output convergence.

20. One or more non-transitory computer-readable storage media including instructions that, when executed by one or more processors, cause the one or more processors to:
generate, using a machine learning classification model, a resolution capability classification for an input data object that comprises an input question and an input document;
generate, using an LLM, an initial predictive output for the input data object based on an initial generative model prompt for the input data object;
identify a classification model output divergence based on a comparison between the resolution capability classification and the initial predictive output; and
in response to the classification model output divergence:
generate an augmented generative model prompt by modifying the initial generative model prompt with a representation of the resolution capability classification, and
generate, using the LLM, an updated predictive output based on the augmented generative model prompt.
